(19) United States
(12) Patent Application Publication
(10) Pub. No.: US 2003/0152270 A1
(43) Pub. Date: Aug. 14, 2003

(54) Image encoding device, decoding device and encoding method, decoding method, and recorded program on which programs of the methods are recorded

(76) Inventors: Hisashi Saiga, Nara (JP); Keisuke Iwasaki, Nara (JP); Kensaku Kagechi, Nara (JP)

Correspondence Address: EDWARDS & ANGELL, LLP, P.O. BOX 9169, BOSTON, MA, 02209, US

(21) Appl. No.: 10/221,765

(22) PCT Filed: Mar. 9, 2001
(86) PCT No.: PCT/JP01/01890

(51) Int. Cl. G06K 9/46; G06K 9/66

(52) U.S. Cl. 382/190; 382/215

(57) ABSTRACT

An image encoding device capable of maintaining high efficiency to encode data and also reducing erroneous substitution of an input pattern through encoding, includes an input pattern extractor (305) extracting an input pattern from image data, a representative pattern extractor (311) comparing extracted input patterns for each constituent portion of the input patterns to extract a single representative pattern from similar input patterns, a representative pattern image compressor (318) compressing an image of a representative pattern, and an input pattern information compressor (317) compressing a position of a coordinate of an input pattern.

### TECHNICAL FIELD

The present invention relates to image encoding and decoding devices and methods and computer-readable recording media having programs of the methods recorded therein. In particular, the present invention relates to those capable of maintaining high efficiency to encode data and also reducing an erroneous substitution of an input pattern that is attributed to encoding.

### BACKGROUND ART

Conventionally, document images have been encoded in methods. These methods are represented by a method employing character recognition to encode a character of a document image as a character code and a method encoding a document image in a manner similar to that applied to encode normal image data.

The former method is characterized in that data having been encoded has a reduced quantity. While the method can enhance performance, it cannot completely eliminate erroneous character recognition. As such, if data is erroneously encoded, a text contained in an image may not be understood, as intended, when the data is decoded.

The latter method exactly applies a generally well-known image compression to document images. In this method, understanding a text is hardly interfered with if an image does not have its quality impaired significantly. The method, however, provides encoded data with a larger quantity than the former method.

To overcome the disadvantages of the two methods, there has been proposed a method using a single pattern to represent a plurality of similar patterns and encoding only the represented pattern, the representative pattern's identification code and the locations at which appear the patterns represented by the representative pattern. This method is disclosed more specifically for example in R. N. Ascher et al. “A Means for Achieving a High Degree of Compaction on Scan-Digitized Printed Text”, IEEE Transactions on Computers, vol. c-23, No. 11, November 1974.

A “pattern” referred to herein mostly corresponds to a character in encoding document images. As such, if the quantity of data of an exact representative pattern encoded is not counted, the quantity of encoding data is ideally only required to accommodate an amount of data required to represent an identification code of each character in an image and positional information corresponding to the identification code.

Furthermore, this method can also be considered as extracting a standard pattern from an input image in character recognition using a pattern matching system.

In this method, erroneous recognition less concerns than when character recognition is used, since the method is only required to determine whether a pattern is similar and it is not required to precisely determine “what” the pattern exactly is, as character recognition is required. Furthermore, as compared with the character recognition using the pattern matching system, the method extracts from an exact input image a pattern corresponding to a standard pattern. As such, if the input image contains a character of a peculiar font, that fact itself would not be an obstacle to encoding.

The method of encoding a representative pattern or the like thus has relatively superior characteristics. Nonetheless it is not used widely at present.

A cause thereof is a difficulty in encoding; it is difficult to have control to reduce erroneous substitution of an input pattern or erroneous substitution of an input pattern with a wrong representative pattern.

Reference will now be made to FIGS. 46A-46B to describe an example of erroneous substitution of an input pattern. FIG. 46A shows an input image and FIG. 46B shows the input image that has been encoded and then decoded. In the FIG. 46A image there exist three pairs of similar patterns, i.e., a pair of patterns 2002 and 2004, a pair of patterns 2006 and 2008, and a pair of patterns 2010 and 2012. In such a case an input pattern can readily be substituted incorrectly, and, as shown in FIG. 46B, patterns 2002, 2008 and 2010 have been substituted with inappropriate patterns 2014, 2016 and 2018, respectively. This results from an input pattern being clustered inappropriately.

With reference to FIGS. 47-52, each input pattern (or character) is represented in dots on a two-dimensional plane. The figures do not indicate a position of an input pattern on an input image. Rather, they schematically indicate a position on a pattern space (a feature vector space) of a feature vector created from an extraction of a feature of an input pattern. Note that while FIGS. 47-52 represent a feature vector in dots on a two-dimensional plane, a pattern space is three or more dimensional if there exist three or more features.

With reference to FIG. 47, input patterns respectively representing two types of characters are represented by a pattern 102 (a circle) and a pattern 104 (a triangle), respectively.

Herein, a representative pattern is selected from input patterns. For example, input patterns in a pattern space each with an Euclidean distance falling within a determined range are classified in a single class and the class is represented by a pattern selected from the input patterns. For example, with reference to FIG. 48, patterns 102 and 104 are classified into classes represented with three circles 112, 114 and 116 and the three classes are represented by patterns 106, 108 and 110 selected, respectively. Note that a representative pattern may be extracted in a method other than clustering based on an Euclidean distance. Correct substitution of an input pattern means that each representative pattern is selected from input patterns representing a single character. FIG. 48 shows an ideal, exemplary clustering allowing an input pattern to be correctly substituted.

Three circles 112, 114 and 116 have patterns 106, 108 and 110, respectively, corresponding to their respective centers and they have a determined radius. A pattern in the circle is substituted with a representative pattern when data is encoded. Note that input patterns of a single type may or may not be represented by a single representative pattern. As shown in FIG. 48, pattern 102 is included in two circles 112 and 114. As such, pattern 102 is represented by two patterns 106 and 108.

If the diameter of the circle, or the Euclidean distance between representative and input patterns that are regarded as belonging to a single class, is increased, then, as shown in FIG. 49, all of the input patterns would be in circle 118 and thus clustered into a single class. Thus, different types of patterns 102 and 104 would be represented by a representative pattern 120, with the result that an input pattern is substituted erroneously, as shown in FIG. 46B.

Thus increasing a circle in diameter for clustering input patterns facilitates erroneous substitution of the input patterns and decreasing the circle in diameter reduces erroneous substitution of the patterns. The reduction of a circle in diameter is considered a good approach.

As shown in FIG. 50, however, if a circle has a diameter indefinitely approximating to zero, erroneous substitution does not occur, although input and representative patterns would have a one to one correspondence therebetween. As such, using a representative pattern to encode an input pattern does not have a difference from encoding the exact input pattern, which does not contribute to reduced quantities of data.

Thus there exists a trade-off relationship between reduction of data in quantity and reduction of erroneous substitution of an input pattern.

Japanese Patent Laying-Open No. 8-30794 discloses a method of extracting a representative pattern from an input pattern, as follows: other than input and representative patterns, there is prepared a pattern referred to as a registration pattern. Initially, a single registration pattern is selected from input patterns and the registration and input patterns are successively collated with each other. If the registration pattern and an input pattern are similar, the registration and input patterns are averaged out to obtain a pattern as a new registration pattern or a predetermined reference is used to select a pattern from the registration or input patterns as a new registration pattern. Input patterns similar to the registration pattern are clustered in a single class.

If there is generated an input pattern which is not similar to any of registration patterns, then the input pattern is set as a new registration pattern and a similar processing is effected. Such a process continues until input patterns have been clustered into any of classes. A registration pattern obtained when the process ends is set as a representative pattern.

If a representative pattern is registered in such a method as described above, however, input patterns are still clustered in a manner similar to that described above. Reducing data in quantity is thus hardly compatible with reducing erroneous substitution of an input pattern.

For example, with reference to FIG. 51, if an input pattern 201 is used as a registration pattern to cluster input patterns without the result that an input pattern is erroneously substituted, input pattern 202 would belong to the same class as input pattern 201, whereas input pattern 203 would belong to a different class. This results in an increased number of representative patterns.

In contrast, with reference to FIG. 52, if pattern 102 is represented by a single pattern, then for example input pattern 204 of pattern 104 would belong to the same class and an input pattern would be substituted erroneously.

Furthermore, for Japanese or any other languages having a large number of characters formed of a plurality of components, a document image needs to be processed particularly carefully. In Japanese Patent Laying-Open No. 8-30794, a component corresponds to an input pattern. As such, whether an input pattern is extracted from identical characters or different characters is not considered. Thus it is possible that a plurality of components forming a so-called separable character on a decoded image is substituted with representative patterns extracted from different characters when it is encoded. If such representative patterns originate from characters different in typeface, however, a decoded image would introduce a significant discomfort. For example, with reference to FIG. 53A, a left component 2106 of a pattern 2100 written in the Mincho typeface and a right component 2108 of a pattern 2102 written in the Gothic typeface are used as representative patterns to encode a Gothic pattern 2110 shown in FIG. 53B on a single plane of a sheet. The decoded image is as shown in FIG. 53A, providing a pattern 2104 formed of Mincho pattern 2106 and Gothic pattern 2108, introducing a significant discomfort. This can be prevented conventionally only by substituting an input pattern with a representative pattern in accordance with strict conditions. This, however, results in an increased number of representative patterns, as described above, and data would be encoded less efficiently.

### DISCLOSURE OF THE INVENTION

The present invention has been made to overcome the above disadvantages.

One object of the present invention is to provide image encoding and decoding devices allowing data to be encoded with high, maintained efficiency and also reducing an erroneous substitution of an input pattern that is attributed to encoding.

Another object of the present invention is to maintain efficiency for encoding and also eliminate discomfort provided by an encoded character of a separable character.

The present invention in one aspect provides an image encoding device including: an input pattern extractor extracting an input pattern from image data; a representative pattern extractor connected to the input pattern extractor to compare extracted input patterns with each other for each constituent portion of the input patterns to extract a single representative pattern from similar input patterns; and an encoding portion encoding an image of the representative pattern and a position of a coordinate of the input pattern.

Partially comparing input patterns allows characters that are similar, as generally observed, but dissimilar, as partially observed, to be distinguished to reduce erroneous substitution of the input patterns.

Preferably the representative pattern extractor includes: a portion matching portion connected to the input pattern extractor to compare extracted input patterns for each constituent portion of the input patterns; a loop detection portion connected to the input pattern extractor to detect a number of annular portions in the input pattern; and a circuit connected to the portion matching portion and the loop detection portion and using outputs from the portion matching portion and the loop detection portion, respectively, to examine similarity between input patterns to be compared with each other, to extract a single representative pattern from similar input patterns.

Detecting the number of annular portions allows characters that are also similar, as partially observed, but in fact different characters to be accurately distinguished to reduce erroneous substitution of an input pattern.

The present invention in another aspect provides an image encoding device including: an input pattern extractor extracting an input pattern from image data; a similarity enlarging portion connected to the input pattern extractor to set for each input pattern an input pattern dissimilar to the input pattern of interest and similar to an input pattern similar to the input pattern of interest as an input pattern similar to the input pattern of interest; and a representative pattern extractor connected to the similarity enlarging portion to compare extracted input patterns to extract a single representative pattern from input patterns determined as being similar to each other; and an encoding portion encoding an image of the representative pattern and a position of a coordinate of the input pattern.

Enlarging in a chain a range in similarity of an input pattern can contribute to a reduced number of representative patterns representing input patterns. Data can thus be encoded with high, maintained efficiency.

The present invention in still another aspect provides an image encoding device including: an input pattern extractor extracting an input pattern from image data; a loop detection portion connected to the input pattern extractor to detect a number of annular portions in an extracted input pattern; a representative pattern extractor connected to the loop detection portion to receive an output from the loop detection portion for use in examining similarity between input patterns to be compared with each other, to extract a single representative pattern from similar input patterns; and an encoding portion encoding an image of the representative pattern and a position of a coordinate of the input pattern.

Detecting the number of annular portions allows characters that are also similar, as partially observed, but in fact different characters to be accurately distinguished to reduce erroneous substitution of an input pattern.

Preferably the representative pattern is a character cut out of the image data.

The representative pattern can be a character cut out of image data. An input pattern can hardly be erroneously substituted through character recognition, as introduced when an input pattern undergoes character recognition and a character code is used to represent a representative pattern. Furthermore, other than that, for separable characters, a decoded image does not provide a discomfort, such as introduced when a component is used as an input pattern.

The present invention in still another aspect provides an image decoding device decoding an image from data encoded by the image encoding device as described above. It includes: an image generation data extraction portion extending encoded data and extracting an image of a representative pattern and a position of a coordinate of an input pattern; and a representative pattern pasting portion connected to the image generation data extraction portion to paste at the position of the coordinate of the input pattern a representative pattern representing the input pattern of interest.

An image can be produced simply by sequentially pasting a representative pattern at a position of a coordinate of an input pattern. The image can thus be reconstructed rapidly.

Still preferably, input patterns have their coordinates encoded by a unit corresponding to a page of a document.

This can facilitate decoding only an image corresponding to a desired page.

The present invention in still another aspect provides a method of encoding an image, including the steps of: extracting an input pattern from image data; comparing extracted input patterns for each constituent portion of the input patterns to extract a single representative pattern from similar input patterns; and encoding an image of the representative pattern and a position of a coordinate of the input pattern.

Partially comparing input patterns allows characters that are similar, as generally observed, but dissimilar, as partially observed, to be distinguished to reduce erroneous substitution of the input patterns.

The present invention in still another aspect provides a method of decoding an image from data encoded by the method as described above. The method includes the steps of: extending encoded data and extracting an image of a representative pattern and a position of a coordinate of an input pattern; and pasting at the position of the coordinate of the input pattern a representative pattern representing the input pattern of interest.

An image can be produced simply by sequentially pasting a representative pattern at a position of a coordinate of an input pattern. The image can thus be reconstructed rapidly.

The present invention in still another aspect provides a computer-readable recording medium having recorded therein a computer-executable program of a method of encoding an image, including the steps of: extracting an input pattern from image data; comparing extracted input patterns for each constituent portion of the input patterns to extract a single representative pattern from similar input patterns; and encoding an image of the representative pattern and a position of a coordinate of the input pattern.

Partially comparing input patterns allows characters that are similar, as generally observed, but dissimilar, as partially observed, to be distinguished to reduce erroneous substitution of the input patterns.

The present invention in still another aspect provides a computer-readable recording medium having recorded therein a computer-executable program of a method of decoding an image, including the steps of: decoding an image from data encoded by the method as described above; extending encoded data and extracting an image of a representative pattern and a position of a coordinate of an input pattern; and pasting at the position of the coordinate of the input pattern a representative pattern representing the input pattern of interest.

An image can be produced simply by sequentially pasting a representative pattern at a position of a coordinate of an input pattern. The image can thus be reconstructed rapidly.

### BRIEF DESCRIPTION OF THE DRAWINGS

In the drawings:

FIG. 1 shows a configuration of an image encoding device of the present invention in an embodiment;

FIG. 2 is a block diagram of a configuration of an input pattern extractor 305;

FIG. 3 is a block diagram of a configuration of a representative pattern extractor 311;

FIG. 4 is a block diagram of a configuration of a loop detector 1001;

FIG. 5 is a block diagram of a configuration of a pattern comparator 1005;

FIG. 6 is a block diagram of an image decoding device of the present invention in an embodiment;

FIG. 7 is a flow chart of an image encoding process;

FIG. 8 shows one example of data stored in an image data buffer 304;

FIG. 9 shows an enlarged portion of an input image;

FIG. 10 shows an input pattern obtained from an input image;

FIG. 11 shows a character cut out of an input image;

FIG. 12 shows one example of an input pattern information 2103;

FIG. 13 shows one example of data stored in an encoded data buffer 320;

FIG. 14 shows one example of representative pattern information 2102;

FIG. 15 shows one example of a representative pattern image 2102;

FIG. 16 is a flow chart of a process for extracting an input pattern from a binary image;

FIGS. 17A-17J are diagrams for illustrating a specific example of a process for extracting an input pattern from a character string;

FIG. 18 is a flow chart of a process for extracting a representative pattern;

FIGS. 19A and 19B show one example of input patterns having different numbers of loops;

FIGS. 20A-36 are diagrams for illustrating a process for reloading a value of a representative pattern label buffer 312;

FIG. 37 is a flow chart of a process for detecting the number of loops in an input pattern;

FIGS. 38A-38D are diagrams for illustrating one example of a process provided by loop detector 1001;

FIG. 39 is a flow chart of a process provided by pattern comparator 1005 comparing an input pattern;

FIGS. 40A and 40B are diagrams for illustrating a process for extracting a feature from an input pattern;

FIGS. 41A-41J are diagrams for illustrating a relationship between a feature vector and a partial vector;

FIGS. 42A-42D are diagrams for illustrating partially different patterns;

FIGS. 43A-43D are diagrams for illustrating patterns having different numbers of loops;

FIG. 44 is a flow chart of a process for decoding encoded data;

FIG. 45 shows one example of a pixel value conversion table 2209;

FIGS. 46A and 46B are diagrams for illustrating one example of erroneous substitution of an input pattern;

FIG. 47 shows a distribution of input patterns;

FIGS. 48-52 are diagrams for illustrating encoding an input pattern conventionally; and

FIGS. 53A 53B are diagrams for illustrating a disadvantage of conventionally encoding an input pattern.

### BEST MODE FOR CARRYING OUT THE INVENTION

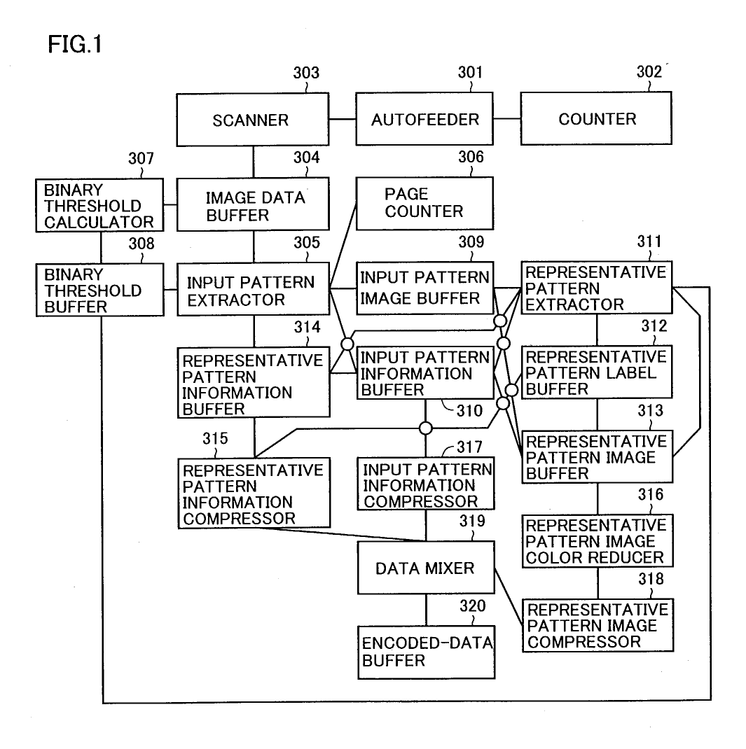

With reference to FIG. 1, the present invention in an embodiment provides an image encoding device including a scanner 303 scanning a plane of a sheet to take in an image, an autofeeder 301 connected to scanner 303 to automatically, successively feed sheets to scanner 303, a counter 302 connected to autofeeder 301 to count the number of pages of sheets being fed to scanner 303, and an image data buffer 304 connected to scanner 303 to store an image taken in by scanner 303.

The image encoding device further includes a binary threshold calculator 307 connected to image data buffer 304 to calculate a binary threshold value for each page, a binary threshold buffer 308 connected to binary threshold calculator 307 to store a binary threshold value for each page in a one-dimensional array, and an input pattern extractor 305 connected to image data buffer 304 and binary threshold buffer 308 to extract an input pattern from an image.

The image encoding device further includes a page counter 306 connected to input pattern extractor 305 to count the number of pages of an image currently being processed, an input pattern image buffer 309 storing an image of an input pattern, an input pattern information buffer 310 connected to input pattern extractor 305 to store the width and length of an input pattern, and a representative pattern extractor 311 connected to input pattern image buffer 309 and input pattern information buffer 310 to extract a pattern representative of an input pattern.

The image encoding device further includes a representative pattern label buffer 312 connected to representative pattern extractor 311, input pattern image buffer 309 and input pattern information buffer 310 to store an array of integers for correlating representative and input patterns, a representative pattern image buffer 313 connected to representative pattern extractor 311 and representative pattern label buffer 312 to store an image of a representative pattern, and a representative pattern information buffer 314 connected to representative pattern extractor 311 to store the width and length of a representative pattern.

The image encoding device further includes a representative pattern information compressor 315 connected to representative pattern information buffer 314 to compress a representative pattern, a representative pattern image color reducer 316 connected to representative pattern image buffer 313 to reduce in color an image of a representative pattern stored in representative pattern image buffer 313, and an input pattern information compressor 317 connected to input pattern information buffer 310 and representative pattern label buffer 312 to mix and compress information of a page count stored in counter 302, information stored in input pattern information buffer 310, and information stored in representative pattern label buffer 312.

The image encoding device further includes a representative pattern image compressor 318 connected to representative pattern image color reducer 316 to compress a representative pattern reduced in color by representative pattern image color reducer 316, a data mixer 319 connected to representative pattern information compressor 315, input pattern information compressor 317 and representative pattern image compressor 318 to link information of a representative pattern, compressed data of an image of a representative pattern and compressed data of information of an input pattern together in single encoded data, and an encoded data buffer 320 connected to data mixer 319 to store data of a document image encoded.

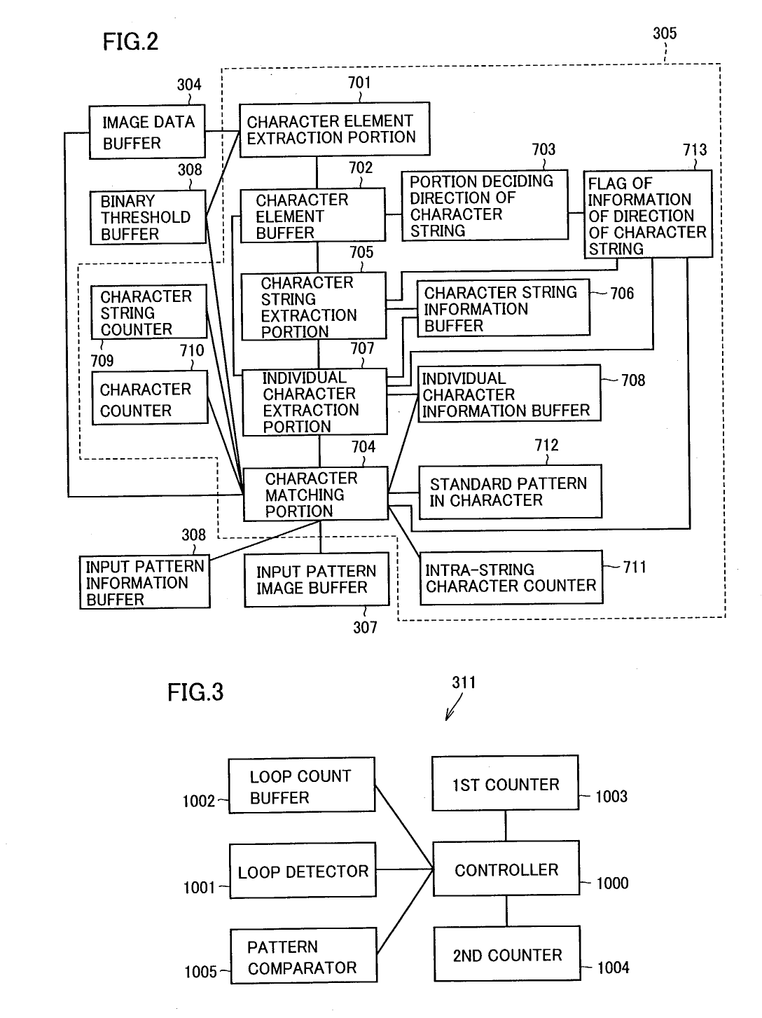

With reference to FIG. 2, input pattern extractor 305 includes a character element extraction portion 701 connected to image data buffer 304 to extract a character element from an image stored in image data buffer 304, a character element buffer 702 connected to character element extraction portion 701 to store a character element extracted by character element extraction portion, a portion 703 connected to character element buffer 702 to determine a direction of a character string in an image, and a flag 713 connected to portion 703 to store information of a direction of a character string.

Input pattern extractor 305 further includes a character string extraction portion 705 connected to character element buffer 702 and flag 713 to extract a character string from an image, a character string information buffer 706 connected to character string extraction portion 705 to store an array of integers each correlating an extracted character string's number and a character element one to one, and an individual character extraction portion 707 connected to character element buffer 702, character string extraction portion 705 and character string information buffer 706 to divide a character string into character candidates.

Input pattern extractor 305 further includes an individual character information buffer 708 connected to individual character extraction portion 707 to store a coordinate of a rectangle circumscribing a candidate of a character, a character string counter 709 counting the number of character strings, a character counter 710 counting a number of characters, an intrastring counter 711 counting the number of characters in a character string, and a character matching portion 704 connected to binary threshold buffer 308, individual character extraction portion 707, character string counter 709, character counter 710, individual character information buffer 708, intra-string counter 711, binary threshold buffer 308 and binary threshold calculator 307 to compare a standard pattern in character 712 and a character extracted from a character string.

With reference to FIG. 3, representative pattern extractor 311 includes a loop detector 1001 detecting the number of annular portions (or loops) contained in an image corresponding to an input pattern, a loop count buffer 1002 storing the number of loops, a first counter 1003 counting the number of input patterns, a second counter 1004 counting the number of input patterns, a pattern comparator 1005 comparing input patterns with each other, and a controller 1000 connected to loop detector 1001, loop count buffer 1002, the first and second counters 1003 and 1004 and pattern comparator 1005 to control connected equipment.

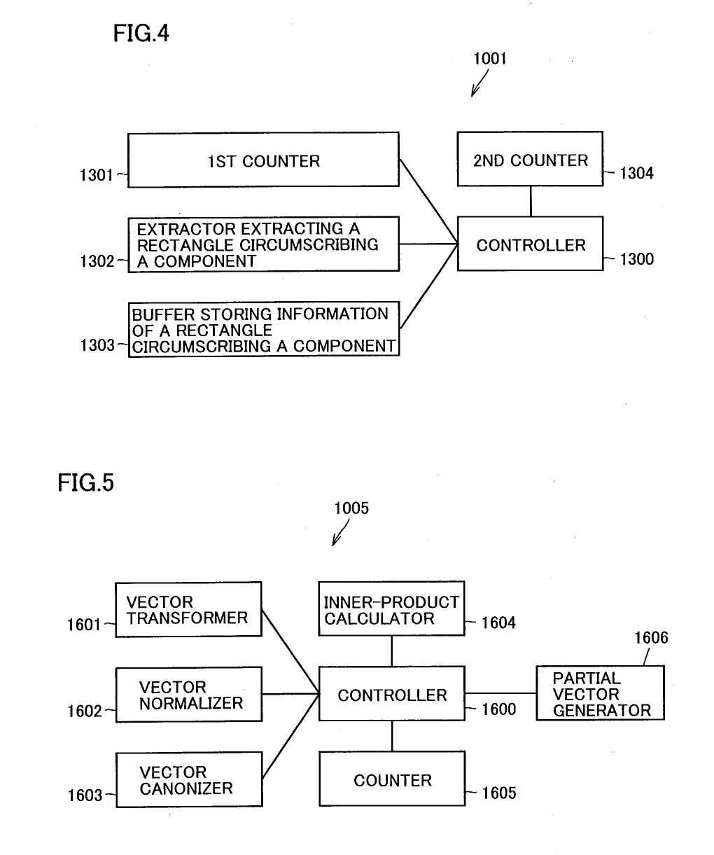

With reference to FIG. 4, loop detector 1001 includes a first counter 1301 indicating the number of an input pattern currently being processed, an extractor 1302 extracting a rectangle circumscribing a component contained in an input pattern, a buffer 1303 for example storing information of a coordinate of a rectangle circumscribing a component, a second counter 1304 counting the number of components, and a controller 1300 connected to the first counter 1301, extractor 1302, buffer 1303 and the second counter 1304 to control connected equipment.

With reference to FIG. 5, pattern comparator 1005 includes a vector transformer 1601 extracting a feature from an input pattern to transform it to a feature vector, a vector normalizer 1602 normalizing a feature vector, a canonizer 1603 canonizing a feature vector, an inner product calculator 1604 calculating an inner product of a feature vector, a counter 1605 counting the number of partial vectors, a partial vector generator 1606 generating a partial vector from a feature vector, and a controller 1600 connected to vector transformer 1601, vector normalizer 1602, vector canonizer 1603, inner product calculator 1604, counter 1605 and partial vector generator 1606 to control connected equipment.

While it is assumed for the image encoding device that a plurality of sheets are scanned and input by a scanner having an autofeeder attached thereto, the present invention is not limited thereto.

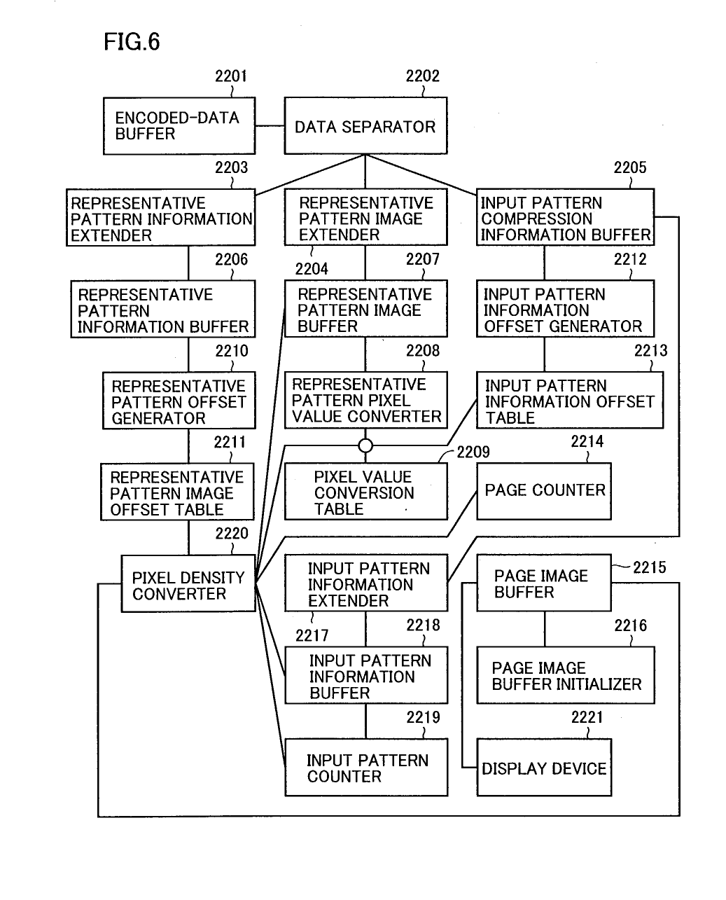

With reference to FIG. 6, data encoded by the image encoding device is decoded to an image by an image decoding device including an encoded data buffer 2201 storing encoded data, a data separator 2202 connected to encoded data buffer 2201 to separate encoded data into representative pattern information, a representative pattern image and input pattern information, and a representative pattern information extender 2203 connected to data separator 2202 to extend representative pattern information.

The image decoding device further includes a representative pattern information buffer 2206 connected to representative pattern information extender 2203 to store extended representative pattern information, a representative pattern image extender 2204 connected to data separator 2202 to extend a representative pattern image, a representative pattern image buffer 2207 connected to representative pattern image extender 2204 to store an extended representative pattern image, an input pattern compression information buffer 2205 connected to data separator 2202 to store compressed input pattern information, and a pixel value conversion table 2209 having a table stored therein for converting a pixel value.

The image decoding device further includes a representative pattern pixel value converter 2208 connected to representative pattern image buffer 2207 and pixel value conversion table 2209 to convert a value of a pixel of a representative pattern, a representative pattern image offset generator 2210 connected to representative pattern information buffer 2206 to generate from data stored in representative pattern information buffer 2206 a location in representative pattern image buffer 2207 at which a representative pattern's image is stored, and a representative pattern image offset table 2211 connected to representative pattern image offset generator 2210 to store an array of integers each correlating a representative pattern's number and an offset value.

The image decoding device further includes an input pattern information offset generator 2212 connected to input pattern compression information buffer 2205 to generate an offset representing a location of each page data in input pattern compression information buffer 2205, an input pattern information offset table 2213 connected to input pattern information offset generator 2212 to store an array of integers each correlating a page number and an offset, a page counter 2214 counting the number of pages, and an input pattern information extender 2217 connected to input pattern compression information buffer 2205 to extend input pattern information.

The image decoding device further includes an input pattern information buffer 2218 connected to input pattern information extender 2217 to store input pattern information, an input pattern counter 2219 counting the number of input patterns, a page image buffer 2215 storing an image for each page, and a page image buffer initializer 2216 connected to page image buffer 2215 to initialize a value of a pixel of an image stored in page image buffer 2215.

The image decoding device further includes a display device 2221 connected to page image buffer 2215 to display an image stored in page image buffer 2215, and a pixel density converter 2220 connected to representative pattern image offset table 2211, input pattern information buffer 2218, input pattern counter 2219, page image buffer 2215, representative pattern image buffer 2207, representative pattern pixel value converter 2208, pixel value conversion table 2209 and input pattern information offset table 2213 to equalize a representative pattern and an input pattern in size.

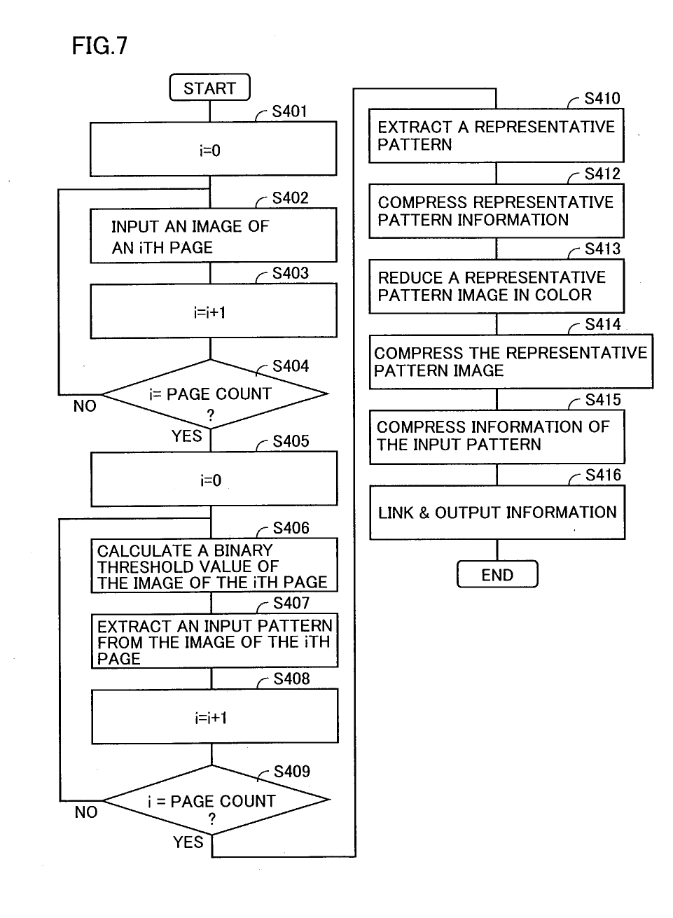

Reference will now be made to FIG. 7 to more specifically describe an image encoding process.

Hereinafter, each plane of sheets of a document will be referred to as a “page.” Furthermore, an array's element number or page count starts with zero, unless otherwise specified, for the sake of illustration. Furthermore, each of loop variables i, j and k that will repeatedly be used to describe different processes is irrelevant between the processes unless otherwise described.

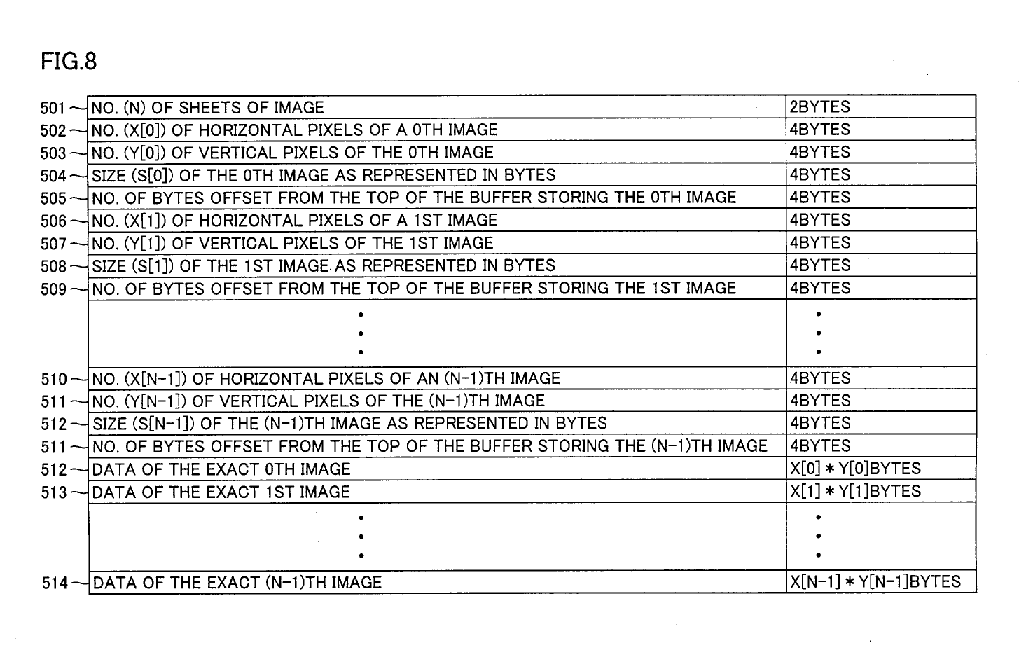

Autofeeder 301 clears counter 302 to 0 (step (S) (401)). If the counter has a value i, scanner 303 scans an ith page, takes in an image and stores the image to image data buffer 304 (S402). FIG. 8 shows one example of data stored to image data buffer 304.

Image data buffer 304 stores a 256-level gray image with each pixel represented by one byte for the sake of illustration. Autofeeder 301 increments counter 302 by one (S403). If counter 302 does not indicate a value equal to a page count (NO at S404), that means that there exists a page which has not been scanned (the ith page), and S402 et seq. are repeated.

If counter 302 indicates a value equal to the page count (YES at S404), input pattern extractor 305 clears page counter 306 to 0 (S405). Binary threshold calculator 307 extracts from image data buffer 304 an image of a page indicated by page counter 306, calculates an optimal binary threshold value, and stores it to binary threshold buffer 308 (S406). The binary threshold value is used in a process for extracting an input pattern, as will be described later. Binary threshold calculator 307 determines a binary threshold value for each page image to maximize distribution between a character region and a background region (or so-called inter-group distribution). Note that the binary threshold value may be calculated in a method other than as described above. S406 may be eliminated if a binary threshold value is not necessary for the process for extracting an input pattern.

Binary threshold buffer 308 is formed of an array having a one-to-one correspondence for each page and it stores an optimal binary threshold value for each page. Herein, a pixel having a value smaller than a binary threshold value is set as a non-background pixel or a noted pixel. If binary threshold buffer 38 stores an array TH including an ith element TH[i], a noted pixel included in the ith page satisfies:

0≦pixel value<TH[i] (1).

While in this scenario, image data buffer 304 stores a 256-level gray image, other types of image are processed, as additionally described below: If an input image is a colored image, a binary threshold value is calculated for example only for a luminance component.

If an input image is a binary image, then S406 can be eliminated since a non-background pixel and a background pixel can obviously be distinguished without a thresholding operation.

Input pattern extractor 305 uses expression (1) to binarize an image of a page indicated by page counter 306. Subsequently the binary image has an input pattern extracted therefrom (S407). An “input pattern” referred to herein corresponds to a small region considered as having therein a large number of similar things in a plane of a sheet.

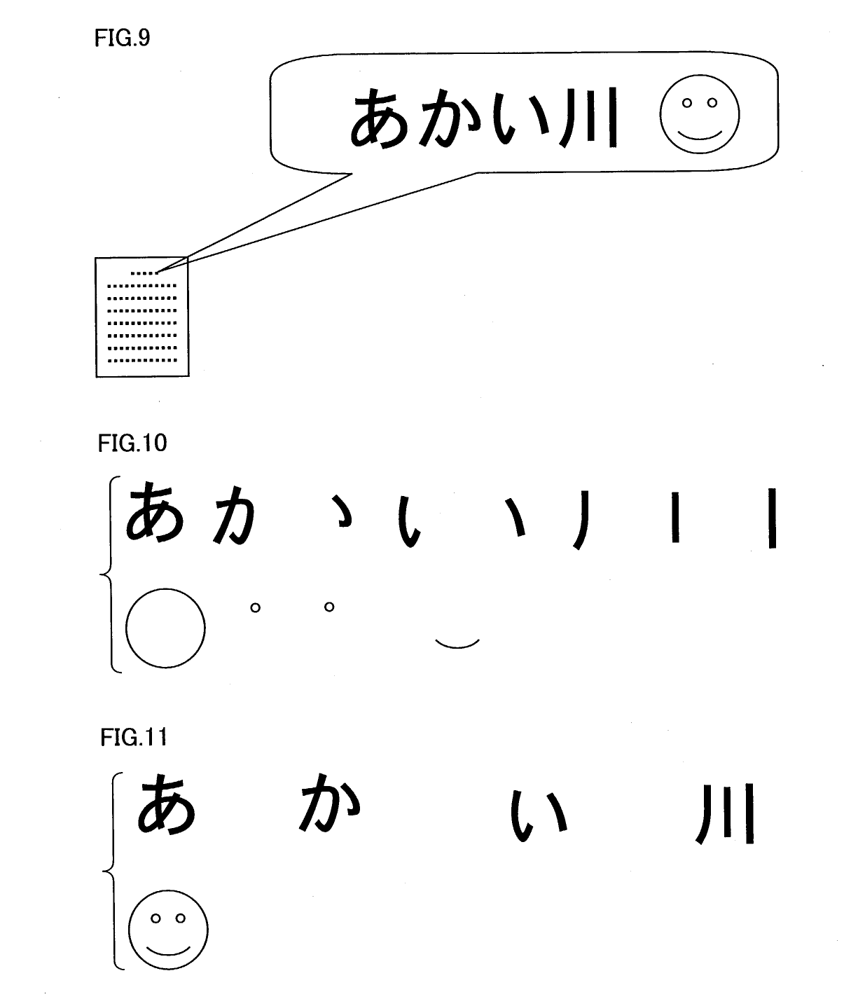

With reference to FIG. 9, an input image is partially enlarged, showing for the sake of illustration that there exist a string of characters and a graphical representation resembling a human face having almost the same size as the characters. From this enlarged portion, components of black pixels (or character-region pixels) are obtained and input patterns are extracted, as shown in FIG. 10. More specifically, 12 input patterns are obtained from the character string and the following graphical representation.

From the same portion a character is cut out and an input pattern is obtained, as shown in FIG. 11. More specifically, five input patterns are obtained from the character string and the following graphical representation. In the following description, a character will be an input pattern, as shown in FIG. 11, although an input pattern is not limited to a character.

Input pattern extractor 305 increments page counter 306 by one (in FIG. 7 at S408). If page counter 306 does not indicate a value matching a page count (NO at S409) then S406 et seq. are repeated until all pages have an input pattern extracted therefrom.

If page counter 306 indicates a value matching the page count (YES at S409) then representative pattern extractor 311 refers to input pattern image buffer 309 and input pattern information buffer 310 to extract a representative pattern and stores the result to representative pattern label buffer 312 and representative pattern information buffer 314 (S410). A “representative pattern” referred to herein means a pattern which can substitute an input pattern in an input image without significantly impairing the image's quality. Step 410 will later be described more specifically.

Representative pattern information compressor 315 compresses a representative pattern stored in representative pattern information buffer 314 (S412). Representative pattern image color reducer 316 reduces in color an image of a representative pattern in representative pattern image buffer 313 (S413) to provide further increased compressibility, reducing an amount of information to a number of levels required to reproduce a character pattern considered as occupying most of an input pattern. In this scenario a 256-level representative pattern is reduced in color to have eight levels for the sake of illustration. The 256 levels are divided at substantially equal intervals into eight equal portions and a decision is made as to which one of eight representative colors 0, 36, 73, 109, 145, 181, 218 and 255 is the closest representative color. A numeral indicating the place of the closest representative color substitutes a pixel value. For example, a pixel value of 120 is closest to representative color 109, and if the representative colors are numbered in ascending order then, with representative color 0 being the 0th color, representative color 109 corresponds to the third representative color. The pixel value of 120 is substituted in S413 by 3.

Representative pattern image compressor 318 compresses a representative pattern reduced in color by representative pattern image color reducer 316 and provides it to data mixer 319 (S414). The representative pattern is compressed mainly either still having a two-dimensional structure as an image or in a mere, one-dimensional array, and it can be compressed in either manner. In this scenario, it is compressed in a one-dimensional array and enthropy-coding using arithmetic-coding is employed, although it may be compressed in different manners.

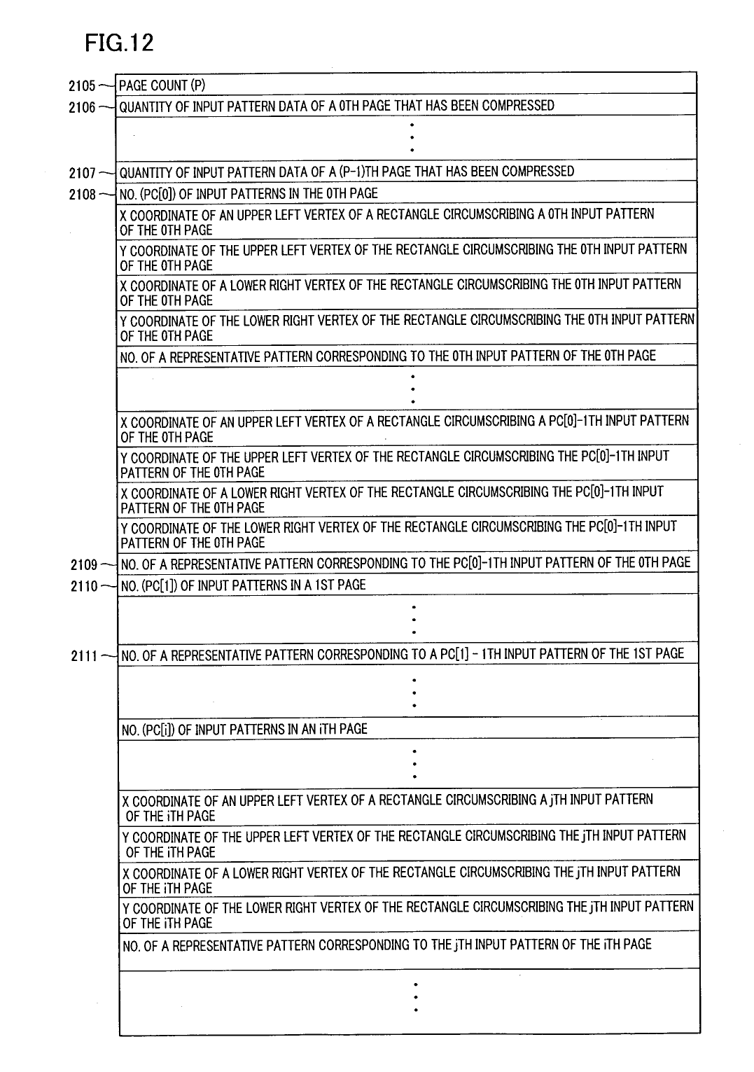

With reference to FIG. 12, input pattern information compressor 317 mixes and compresses information of a page count stored in counter 302, information stored in input pattern information buffer 310 and information stored in representative pattern label buffer 312 and supplies it to data mixer 319 (S415). Note that input pattern information compressor 317 produces input pattern information for each page and compresses it for the page.

For example, a number 2108 through a number 2109 serves as a single unit of compression. Number 2108, represented by PC[0], is the number of input patterns in a 0th page. Number 2109 is the number of a representative pattern corresponding to a (PC[0]-1)th input pattern in the 0th page. After they are compressed their resultant byte count is stored as a quantity 2106 of the input pattern data of the 0th page that has been compressed. A similar procedure is followed for each page; with data compressed for each page, the data can be decoded for each page, decoding the data can require a reduced memory capacity, and the page can be accessed randomly.

Note that herein the quantity of compressed input pattern data is stored for each page and in accordance with the quantity the input pattern information is accessed. Apart from this quantity, for each page an offset to input pattern information (an offset from a page count 2105) may be stored and the input pattern information may be accessed.

Note that input pattern information compressor 317 does not compress information from page count 2105 (represented by “P”) through quantity 2107 of input pattern data of a (P-1)th page that has been compressed, and it outputs the information as it is.

Input pattern information compressor 317 uses enthropy-coding employing arithmetic-encoding to compress data, although it may compress data by other methods.

Data mixer 319 links the information of a representative pattern, the image of the representative pattern and the compressed data of information of the input pattern obtained in S412, S413 and S415, respectively, to provide single encoded data and output it to encoded data buffer 320 (S416). Encoded data buffer 320 thus stores data of a document image encoded.

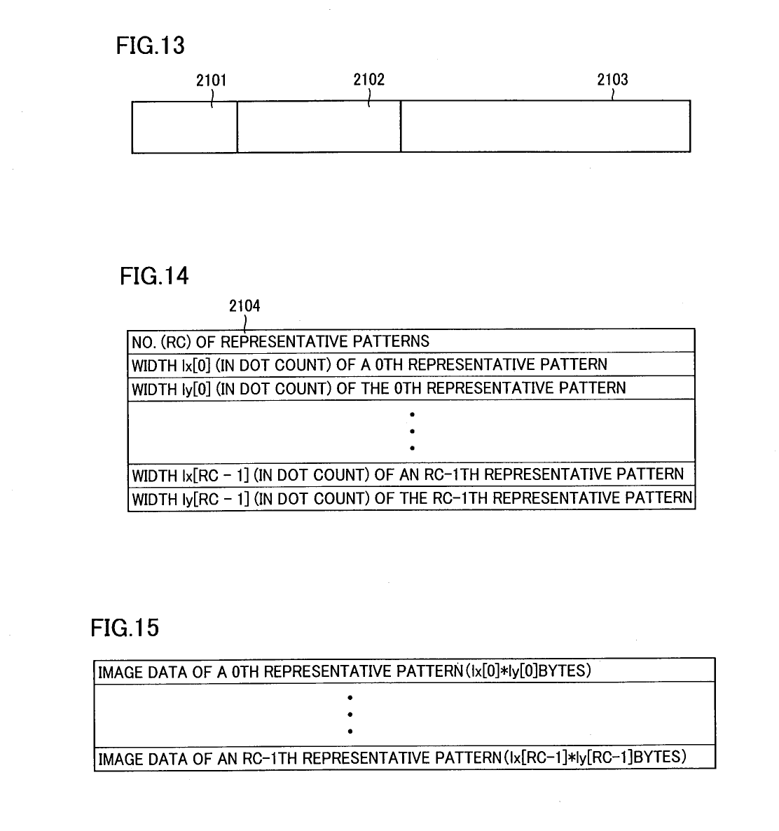

With reference to FIG. 13, the data stored in encoded data buffer 320 includes representative pattern information 2101, representative pattern image 2102 and input pattern information 2103. When representative pattern information 2101, representative pattern image 2102 and input pattern information 2103 are decoded, data can be obtained, as shown in FIGS. 14, 15 and 12, respectively.

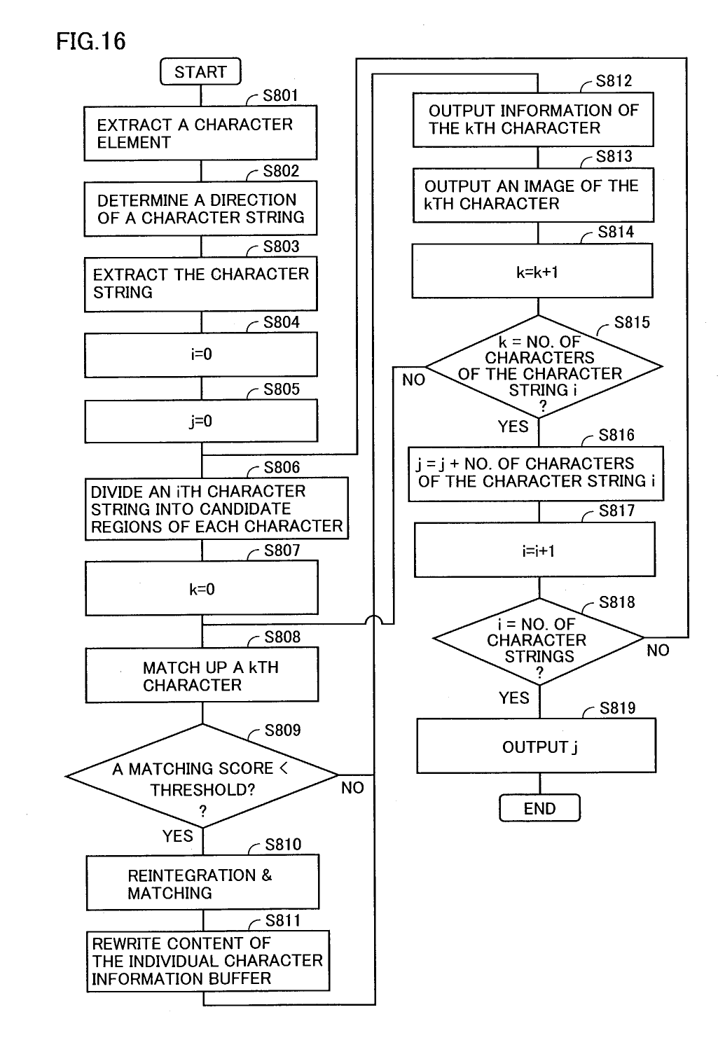

With reference to FIG. 16, the FIG. 7 step 403 will be described more specifically.

If a character is an input pattern, as described in the present embodiment, input pattern extractor 305 in character recognition does not output a character code corresponding to each character extracted from an image borne on a sheet. Rather, it stores an image of each character to input pattern image buffer 309 and the length and width of an input pattern to input pattern information buffer 310.

Character element extraction portion 701 extracts a character element from an image stored in image data buffer 304 or an image of a page to currently be processed and stores to character element buffer 702 information regarding a rectangle circumscribing the character element (S801). A “character element” indicates a component of black pixels (character-region pixels). Character element buffer 702 stores x and y coordinates of an upper left vertex of a circumscribing rectangle and those of a lower right vertex of the rectangle. Japanese Patent Laying-Open No. 5-81474 discloses one example of a method of extracting from an image a rectangle circumscribing a component of a character-region pixel. To effect S801, a binary threshold value stored in binary threshold buffer 308 is used to previously binarize an image.

The portion which determines a direction of a character string 703 refers to character element buffer 702 to determine whether a character string in an image has a vertical direction or horizontal direction and stores the decision to the flag of information of the direction of the character string 713 (S812). Japanese Patent Laying-Open No. 11-73475 discloses one example of determining a direction of a character string provided in an image.

Character string extraction portion 705 refers to character element buffer 702 and flag 713 to extract a character string and rewrite content of the character string information buffer (S803). For example, Japanese Patent Laying-Open No. 5-81474 discloses that an arrangement of a character element is referred to to extract a character string. In character string information buffer 706 a character string's number and a character element are correlated one to one and stored in the form of an integer array.

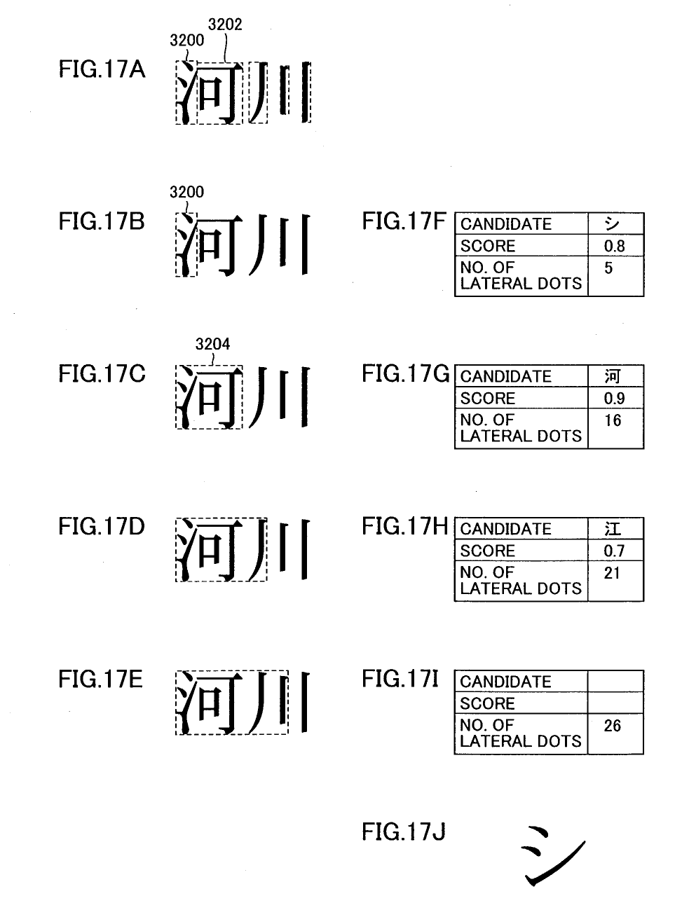

Character matching portion 704 initializes character string counter 709 to 0 (S804) and initializes string counter 710 to 0 (S805). Hereinafter, character sting counter 709 indicates a value i and character counter 710 indicates a value j. Furthermore, each character string is processed as follows: individual character extraction portion 707 divides the ith character string into character candidate regions (S806). More specifically, for example if a laterally written character string is processed, then, with reference to FIG. 17A, the character string is divided by individual character extraction portion 707, as indicated in the figure by dotted lines, into individual character candidate regions. This is accomplished by integrating character elements (components in this case) having their circumscribed rectangles overlapping in a direction perpendicular to the direction of the character string, so as to present the character elements as a single character element.

For example, in FIG. 17A, a candidate region 3200 is formed by three components circumscribed by rectangles, respectively, overlapping in a direction perpendicular to that of the character string (in this example the rectangles overlap in a vertical direction). Accordingly, the three circumscribed rectangles are integrated by individual character extraction portion 707 and a coordinate of the integral circumscribed rectangle is stored to individual character information buffer 708 in the same form as character element buffer 702. Character candidate regions are stored sequentially from the string's left to right when flag 713 indicates that the string is laterally written, and they are stored sequentially from the string's top to bottom when the flag 713 indicates that the string is vertically written. Furthermore, individual character information buffer 708 also stores information on how many characters exist for each character string.

Character matching portion 704 initializes intra-string character counter 711 to 0 (S807). Hereinafter counter 711 will indicate a value k. Character matching portion 704 refers to individual character information buffer 708 and image data buffer 304 to collate a kth character in a character string with all standard patterns in character 712 and the most significant similarity is selected as a matching score (S808).

Note that similarity between standard pattern in character 712 corresponding to each recognition category and an input pattern is calculated in accordance with multiple similarity. As such, similarity maximally has a value of one. Multiple similarity is a known technique. An exemplary feature for use in similarity calculation is mesh feature. It may of course be other features.

If the matching score is not less than a prescribed threshold value (NO at S809) a decision is made that an input pattern has been extracted successfully and character matching portion 704 stores information of a coordinate of the kth character element to input pattern information buffer 310 (S812). Furthermore, character matching portion 704 cuts out of image data buffer 304 an image of a character based on a rectangle circumscribing the character element and stores it to input pattern image buffer 309 (S813).

Character matching portion 704 increments intra-string character counter 711 by one (S814) and if the end of the character string has been reached (YES at S815) then the value of intra-string character counter 711 is added to that of character counter 710 (S816). The value of counter 711 at that time indicates the number of characters extracted from the ith character string having just been processed.

Character string counter 709 is incremented by one (S817). If character string counter 709 does not indicate a value matching a character string count of interest (NO at S818), an unprocessed character string still exists and the control returns to S806.

Character string counter 709 indicating a value matching the character string count (YES at S818) indicates that all character strings have completely been processed. Accordingly, the value of character counter 710 is written to input pattern information buffer 310 and the process ends (S819).

If the matching score is less than a prescribed threshold value (YES at S809) then a reintegration and matching process is effected (S810), as will be described later. As a result of the reintegration and matching process, individual character information buffer 708 has its content rewritten (S811) and S812 et seq., as described previously, are effected.

Reference will now be made to FIGS. 17A-17J to describe the FIG. 16 step 810 (the reintegration and matching process). FIG. 17A indicates character candidate regions extracted from a laterally written character string by individual character extraction portion 707. The character candidate regions are surrounded by broken lines and it can be seen that five such regions have been extracted. With reference to FIGS. 17B and 17F, in S808, character matching portion 704 matches candidate region 3200 with a character of the Katakana alphabet, as shown in FIG. 17H, and a matching score of 0.8 is obtained. The numerical value of 0.8 is not necessarily a large value. This is because there exists a significant difference in details between candidate region 3200 and the Katakana character shown in FIG. 17J.

If in S809 a threshold value of 0.85 is used, then the S809 condition is not satisfied (YES at S809) and the reintegration and matching process (S810) is effected. More specifically, character candidate regions are integrated sequentially within the range of a character width as determined. Whenever they are integrated, character matching portion 704 calculates similarity between a character candidate region and all standard patterns in character 712 and extracts a character candidate region providing the highest matching score. FIGS. 17B, 17C and 17D each show a character candidate region having no more than a determined character width. With reference to FIGS. 17F, 17G and 17H, the FIGS. 17B, 17C and 17D regions attain matching scores of 0.8, 0.9 and 0.7, respectively. Of the three character candidate regions, the FIG. 17C region indicates the highest matching score. Accordingly, the FIG. 17C region is adopted as an input pattern.

The reintegration and matching process as described above (the FIG. 16 step 810) results in a reduced number of characters of a noted character string. As such, the string's character count and its characters′ coordinates and the like that are stored in individual character information buffer 708 are also changed accordingly (S810). For example, in the example used herein, candidate region 3200 and 3202 shown in FIG. 17A are integrated together and a single character is extracted to decrease by one the number of the characters of the character string. Furthermore, a coordinate of character region 3202 stored in individual character information buffer 708 is erased and that corresponding to candidate region 3200 is rewritten with that of candidate region 3204 shown in FIG. 17C (S811).

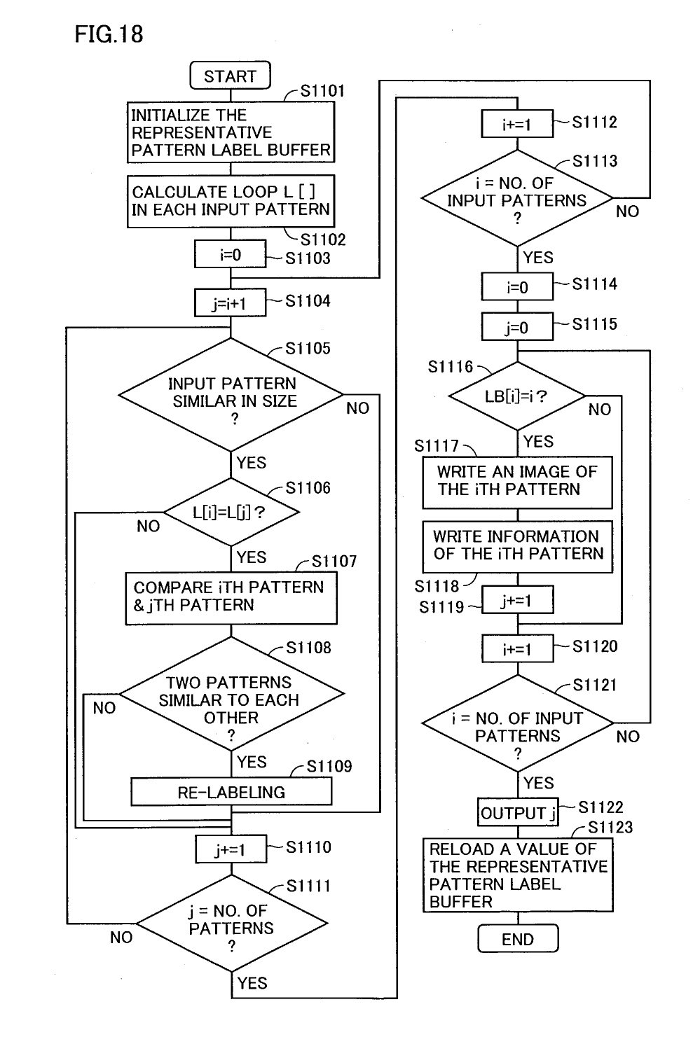

Reference will now be made to FIG. 18 to more specifically describe a process for extracting a representative pattern (the FIG. 7 step 410).

Controller 1000 initializes representative pattern label buffer 312 (S 1101). Representative pattern label buffer 312 is an integer array for correlating representative and input patterns one to one. Representative pattern label buffer 312 has a subscript corresponding to an input pattern's number and representative pattern label buffer 312 has an element corresponding to a representative pattern's number. The initialization of representative pattern label buffer 312 means that for each element a different value is substituted. Hereinafter, representative pattern label buffer 312 has each element represented by LB[i], wherein i is equal to 0, 1, . . . , and the buffer is initialized to provide LB[i]=i, for the sake of illustration.

Loop detector 1001 refers to binary threshold buffer 308, input pattern image buffer 309 and input pattern information buffer 310 to detect the number of loops contained in an image corresponding to an input pattern and stores it to loop count buffer 1002 (S1102). A “loop” means an annular portion. Loop count buffer 1002 is an integer array with a subscript corresponding to an input pattern's number and an element corresponding to a loop count. In the following description, loop count buffer 1002 has an ith element represented by L[i] for the sake of illustration. In other words, an ith input pattern includes a number L[i] of loops.

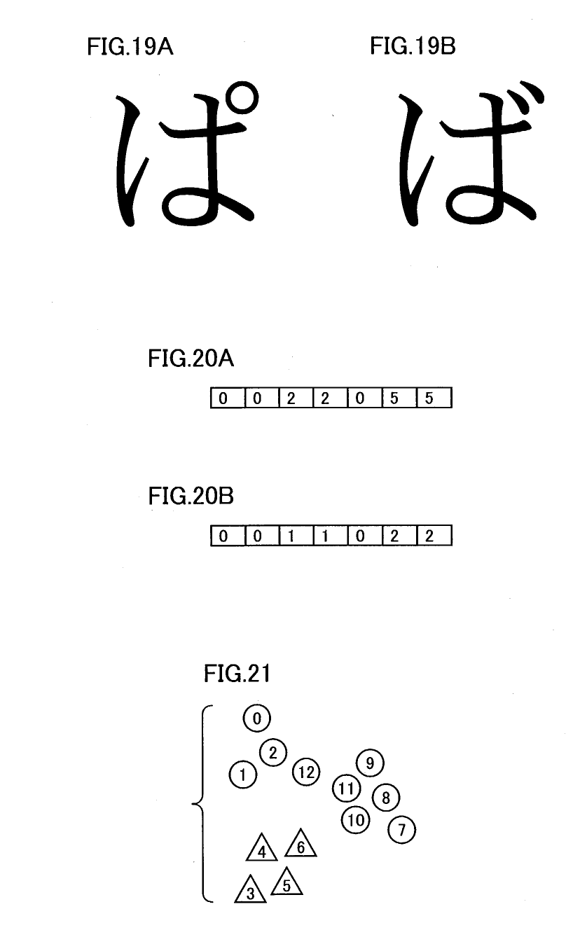

In the loop count detection discussed herein, a noted pixel is selected in accordance with a criterion similar to that of input pattern extractor 305. That is, a non-background pixel is set as a noted pixel. FIG. 19A shows an image having a loop count of two and FIG. 19B shows an image having a loop count of one. Step 1102 will later be described more specifically.

Controller 1000 initializes the first counter 1003 to 0 (the FIG. 18 step 1103) and adds to the second counter 1004 the value of the first counter 1003 plus one (S1004). In the following description, the first counter 1003 indicates a value i and the second counter 1004 indicates a value j.

Controller 1000 determines whether i-and j-th input patterns are similar in size (S1105). This is done by extracting and comparing the two input patterns in width and length.

If the ith input pattern is circumscribed by a rectangle having an upper left vertex having coordinates (sx0[i], sy0[i]) and a lower right vertex having coordinates (ex0[i], ey0[i]) then the ith input pattern has width lx[i] and length ly[i] and the jth input pattern has width lx[j] and length ly[j], as represented by the following equations:

lx[i]=ex0[i]−sx0[i]+1 (2)

ly[i]=ey0[i]−sy0[i]+1 (3)

lx[j]=ex0[j]−sx0[j]+1 (4)

ly[j]=ey0[j]−sy0[j]+1 (5).

If the following equations:

abs (lx[i]−lx[j])×4≦max (lx[i], lx[j]) (6)

abs (ly[i]−lx[j])×4≦max (ly[i], ly[j]) (6)

are both satisfied then a decision is made that the i-and j-th input patterns are similar in size, wherein abs(x) indicates an absolute value of x and max (x, y) indicates that of x and y. More specifically, they are determined as being similar in size when the difference between width and length is not so large when it is compared with the exact width or length.

If the input patterns are similar in size (YES at S1 105) then controller 1000 determines whether number L[i] of loops in the ith input pattern and number L[j] of loops in the jth input pattern are equal (S1107).

If loop counts L[i] and l[j] are equal (YES at S1106) then pattern comparator 1005 compares the i-and j-th input patterns (S1107).

If the i-and j-th input patterns are similar (YES at S1105) then controller 1000 rewrites representative pattern label buffer 312 (S1109), as follows: controller 1000 substitutes a common value min (LB[i], LB[j]) to elements LB[i] and LB[j] of representative pattern label buffer 312 respectively corresponding to the i-and j-th input patterns determined as being similar. Furthermore, controller 1000 also substitutes the common value min (LB[i], LB[j]) to an element having the same value as element LB[i] or LB[j] that is provided before it is updated. Herein, min (LB[i], LB[j]) indicates a minimal value of LB[i] and LB[j].

Controller 1000 increments the second counter 1004 by one (S1110). Controller 1000 determines whether the second counter 1004 has value j equal to a number of input patterns (S1111) and if not (NO at S1111) then controller 1000 returns to S1105.

When the second counter 1004 has value j equal to the number of input patterns (YES at S1111), comparison for the ith input pattern has completely been finished and controller 1000 increments the first counter 1003 by one (S1112).

Controller 1000 examines whether the first counter 1003 has value i equal to the number of input patterns (S1113) and if not (NO at S1113) then controller 1000 returns to S1004 to start comparison for the ith input pattern.

The first counter 1003 indicating value i equal to the number of input patterns (YES at S1113) indicates completion of comparison for all combinations of input patterns and controller 1000 again initializes the first and second counters 1003 and 1004 to 0 (S1114, S1115).

Controller 1000 determines whether LB[i]=i is established (S1116). If LB[i]=i (YES at S1116) then controller 1000 sets the ith input pattern as a representative pattern by reading an image of the ith input pattern from input pattern image buffer 309 and writing it to representative pattern image buffer 313 (S1117). Furthermore, controller 1000 reads information of the ith input pattern from input pattern information buffer 310 and writes it to representative pattern information buffer 314 (S1118). Furthermore, controller 1000 increments the second counter 1004 by one (S1119).

Only when the condition that LB[i]=i is satisfied the ith input pattern is set as a representative pattern, so that only a single representative pattern is selected from input patterns belonging to a single cluster. Any other method may be used that allows only a single representative pattern to be selected from input patterns.

In S1118, the ith input pattern's width lx[i] and length ly[i] are obtained in accordance with expressions (2) and (3).

Controller 1000 increments the first counter 1003 by one (S1120). Controller 1000 determines whether the first counter 1003 indicates value i matching the number of input patterns (S1121). If not (NO at S1121) then the controller 1000 returns to S1116.

If they match (YES at S1121) then, with reference to FIG. 14, controller 1000 writes value j of the second counter 1004 as number 2104 of representative patterns to representative pattern information buffer 314 (S1122) and reloads a value of representative pattern label buffer 312 (S1123), as described hereinafter.

With reference to FIG. 15, representative pattern image buffer 313 has a representative pattern's image data written in raster-scan order. Such a data structure is merely an example and it is needless to say that other data structures may be applied.

Step 1123 will now be described. There are j representative patterns. However, representative pattern label buffer 312 can have an element assuming a value ranging from 0 to “the number of input patterns minus one.” Accordingly, representative pattern label buffer 312 has an element having a value at intervals. Controller 1000 exchanges an element of representative pattern label buffer 312 so that the buffer has elements falling within a range of 0 to (j−1) and also maintains a relationship in magnitude between the elements. For example, with reference to in FIG. 20A, representative pattern label buffer 312 having elements 0, 2 and 5 is reloaded, as shown in FIG. 20B.

Note that while in S1117 an input pattern satisfying LB [i]=i is exactly set as a representative pattern, a plurality of input patterns having LB [i] equal in value, i.e., a plurality of input patterns belonging to a single cluster may alternatively be used to produce a representative pattern. For example, input patterns that are enlarged or reduced and equalized in size may be averaged out to provide a representative pattern. It should be noted, however, that in general, such a synthesis process is not always effective as it provides an image represented by a blurred pattern.

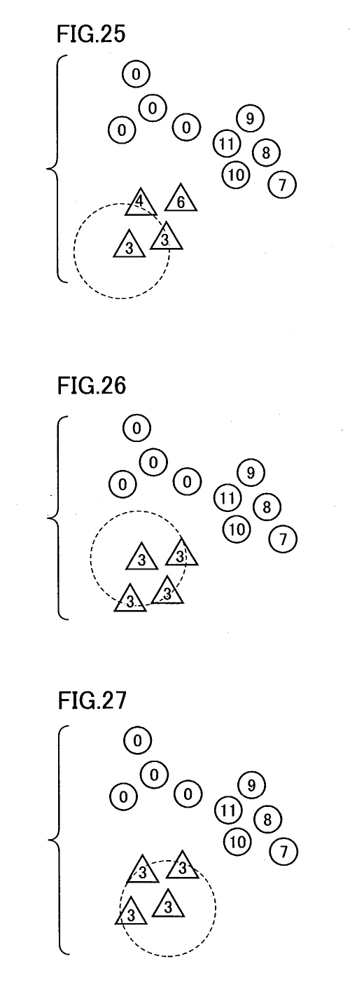

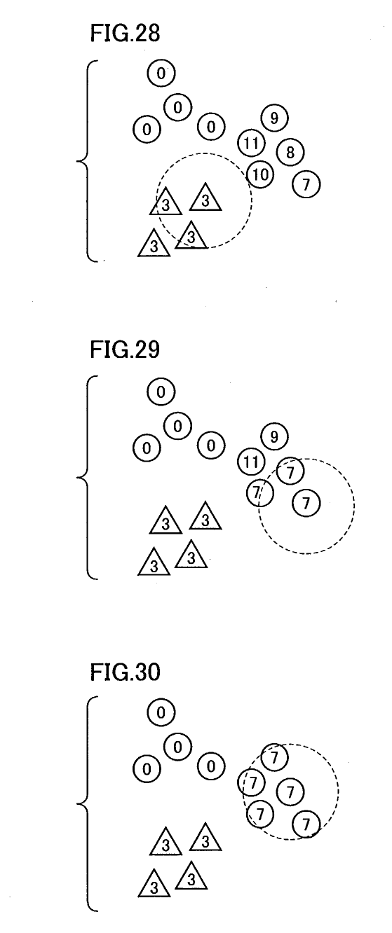

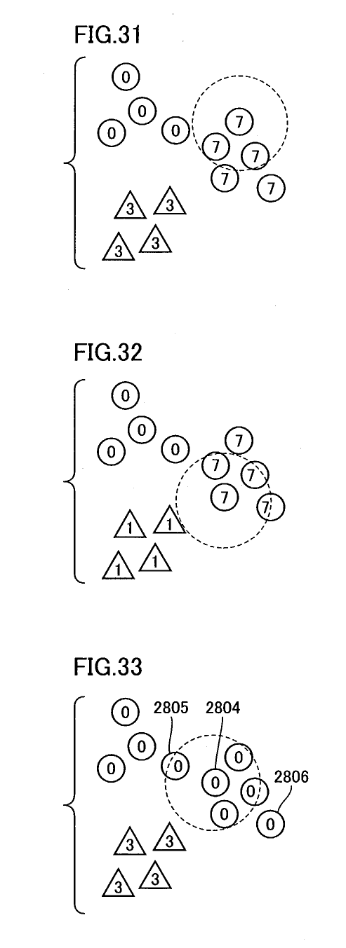

With reference to FIGS. 21-36, representative pattern label buffer 312 for example has a value changed, as described hereinafter. FIG. 21 shows two types of 13 input patterns in total arranged on a pattern space. In the figure, a numeral indicates a value of a representative pattern labels stored in representative pattern label buffer 312 that is provided immediately after S1102. The numeral also matches an input pattern's number stored in input pattern information buffer 310.

Hereinafter FIGS. 22 through 34 show a variation of a value of a representative pattern label after the S1104-S1112 process has been effected while the first counter 1003 has value i incremented by one. S1107 is effected for all combinations of input patterns. Herein, for the sake of illustration, whether two input patterns are similar or not is determined by whether an Euclidean distance on a pattern space is no more than a determined threshold value, and a circle indicated by a dotted line indicates a range of a distance determined as being similar to a pattern located at the center. For example, FIG. 22 shows a state of representative pattern label buffer 312 attained when S1112 completes when i=0. A decision is made that a 0th input pattern 2801 and a first input pattern 2802 are similar and accordingly in S1109 representative pattern label buffer 312 is rewritten in value, as shown in FIG. 22.

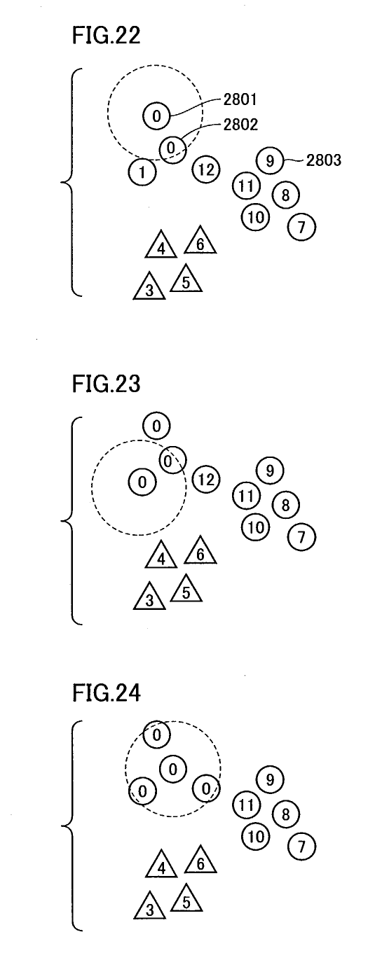

In an initial state shown in FIG. 21, LB[0]=0 and LB[1]=1. Step 1109 rewrites LB[1] to have the same value as LB[0]. Immediately before S1109 is effected, there does not exist any other representative pattern label that is assigned the same value as LB[0] or LB[1]. As such, other representative pattern labels maintain values as they are. For example, a decision is not made that a ninth input pattern 2803 is similar to input pattern 2801 and a representative pattern label LB[9] at that time remains to be nine. Hereinafter FIGS. 23 through 34 show a value of representative pattern label buffer 312 provided when S1112 completes while i changes from 1 to 12. For example, in FIG. 33, which corresponds to i=11, a decision is made that a 11th input pattern 2804 and a 12th input pattern 2805 are similar. Accordingly, when S1112 completes, LB[11]=0 and LB[12]=0. A decision is not made that a 7th input pattern 2806 is similar to input pattern 2804, as shown in the figure. However, LB[7]=LB[11] has already been indicated in a previous process. As such, by S1109 LB[7] has also been rewritten to be 0.

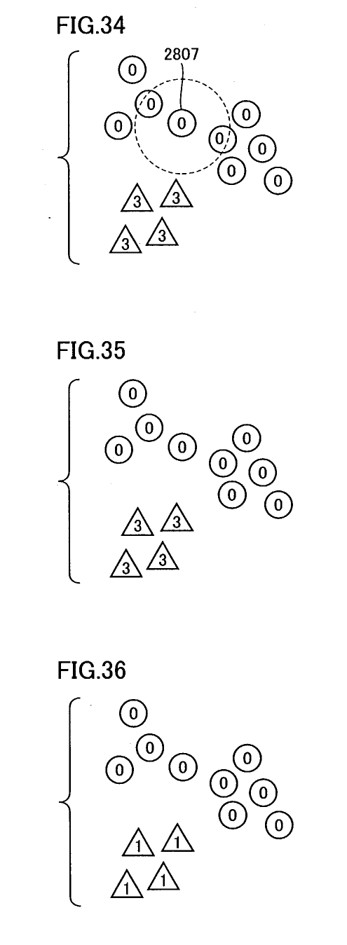

FIG. 34 corresponds to i=12. However, LB[12] has already been written to be 0, and any representative pattern labels corresponding to input patterns determined as being similar to the 12th input pattern 2807 have a value of 0. As such, representative pattern label buffer 312 does not vary in value.

FIG. 35 shows a state attained when S1104 is effected. FIG. 36 shows a state attained after S1123 ends. Representative pattern label buffer 312 is reloaded (S1123) to update a representative label's value from 3 to 1.

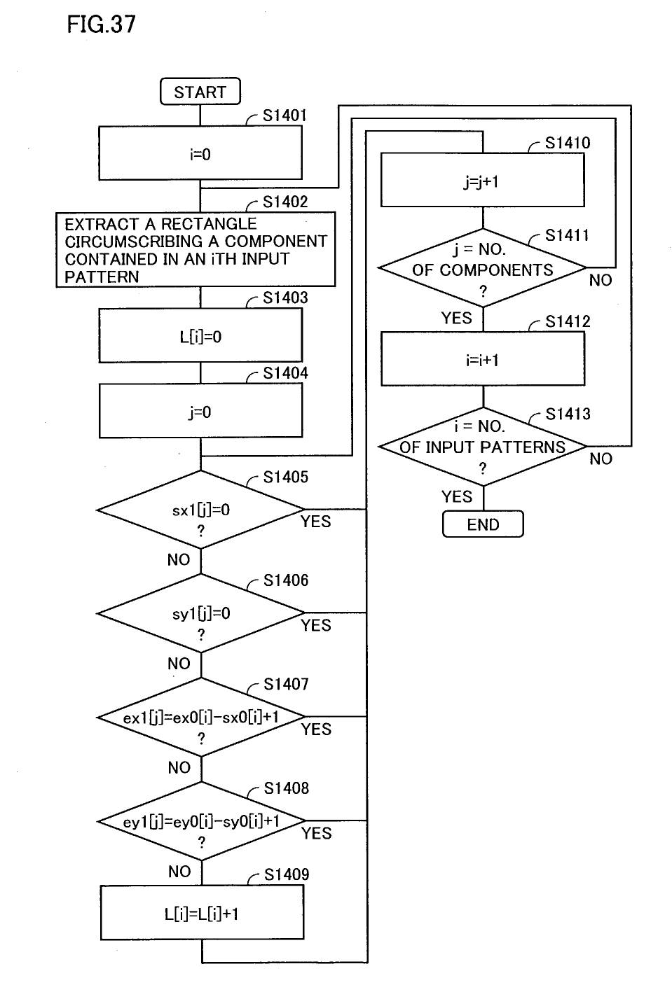

With reference to FIG. 37 the FIG. 18 step 1102 will be described more specifically.

Controller 1300 initializes the first counter 1301 to 0 (S1401). Hereinafter the first counter 1301 indicates a value i. The value of the first counter 1301 indicates the number of an input pattern currently being processed in loop detector 1001.

Controller 1300 uses the extractor extracting a rectangle circumscribing a component 1302 to extract a component of a background region from an input pattern indicated by the first counter 1301. Controller 1300 produces a rectangle circumscribing each component and stores information thereof to the buffer storing information of a rectangle circumscribing a component 1303 (S1402). More specifically, it extracts from input pattern information buffer 310 a page number p[i] to which the ith input pattern belongs. This can be done by setting as a noted pixel a pixel satisfying the following equation:

TH[p[i]]≦pixel value<256 (8),

wherein TH[p[i]] represents a binary threshold value of an image of the p[i]th page stored in binary threshold buffer 308. This means that the noted pixel is a background region, rather than a non-background region. Other than that, extractor 1302 may operate, as disclosed in Japanese Patent Laying-Open No. 5-81474.

Buffer 1303 stores a rectangle count RC, and x and y coordinates of an upper left vertex of each rectangle and those of a lower right vertex of the rectangle. Hereinafter, a kth rectangle will have an upper left vertex represented by (sx1[k], syl[k]) and a lower right vertex represented by (ex1[k], ey1[k]).

Controller 1300 initializes an ith element L[i] of loop count buffer 1002 to 0 (S1403) and the second counter 1304 to 0 (S1404). The second counter 1304 has a value represented herein by j. Controller 1300 determines whether a jth rectangle in buffer 1303 is in contact with an edge of an input pattern (S1405-S1408). More specifically, it determines whether any of the following equations:

sx1[j]=0 (9)

sy1[j]=0 (10)

ex1[j]=ex0[i]−sx0[i] (11)

ey1[j]=ex0[i]−sy0[i] (12)

is established, wherein (sx0[i], sy0[i]) and (ex0[i], ey0[i]) respectively represent xy coordinates of upper left and lower right vertexes, respectively, of a rectangle circumscribing the ith input pattern stored in input pattern information buffer 310.

If any of the above four conditions is established (YES at S1405, S1406, S1407 or S1408) then controller 1300 increments the second counter 1304 by one (S1410).

If any of the conditions is not established (NO at S1405, S1406, S1407 and S1408) then controller 1300 increments the ith element L[i] of loop count buffer 1002 by one (S1409) and proceeds with S1410.

After S1410 is effected, controller 1300 determines whether the second counter 1304 has value j matching the number of rectangles extracted by extractor 1302 (S1411). If so (YES at S1411) then controller 1300 increments the first counter 1301 by one (S1412). If not (NO at S1411) then the controller returns to S1405.

After S1412 is effected, controller 1300 determines whether the first counter 1301 indicates value i matching the number of input patterns (S1413). If so (YES at S1413) then the process ends. If not (NO at S1413) then controller 1300 returns to S1402.

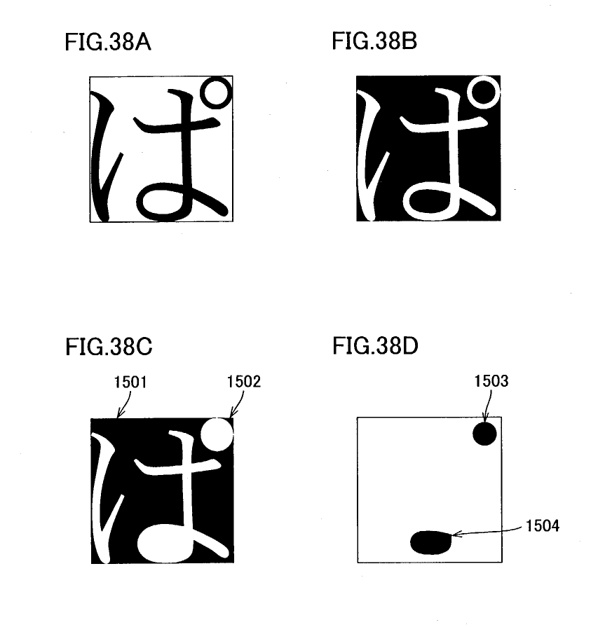

Reference will now be made to FIGS. 38A-38D to describe one example of a process provided by loop detector 1001. If FIG. 38A shows an input pattern, FIG. 38B displays a non-background region and a background region that are inverted. A region in FIG. 38B that is represented in black is a background region and it is a region noted by extractor 1302. FIG. 38C shows components 1501 and 1502, which are extracted from the FIG. 38B image that are each circumscribed by a rectangle contacting an edge of an input pattern. FIG. 38D shows components 1503 and 1504 extracted from the FIG. 38B image that are each circumscribed by a rectangle spaced from an edge of an input pattern.

By counting the number of components, such as components 1503 and 1504, that are each circumscribed by a rectangle spaced from an edge of an input pattern, the number of loops in a non-background region can be calculated.

Thus, noting a background region, extracting therefrom rectangles circumscribing components, and counting the number of rectangles that fail to contact an edge of the input pattern, allows the number of loops in a non-background region to be calculated more readily than detecting loops and counting the number thereof as conventional.

Furthermore by applying such a configuration a condition can be imposed on the size and geometry of the opening of a loop to be detected. For example, “ignoring the number of loops having a width or length of no more than a determined value” can additionally be introduced readily by calculating ex1[j]−sx1[j] and ey[j]−sy1[j] to ignore any that fails to satisfy the condition. Any other conditions are similar that can substitute for a condition related to the size and geometry of a rectangle circumscribing the opening of a loop.

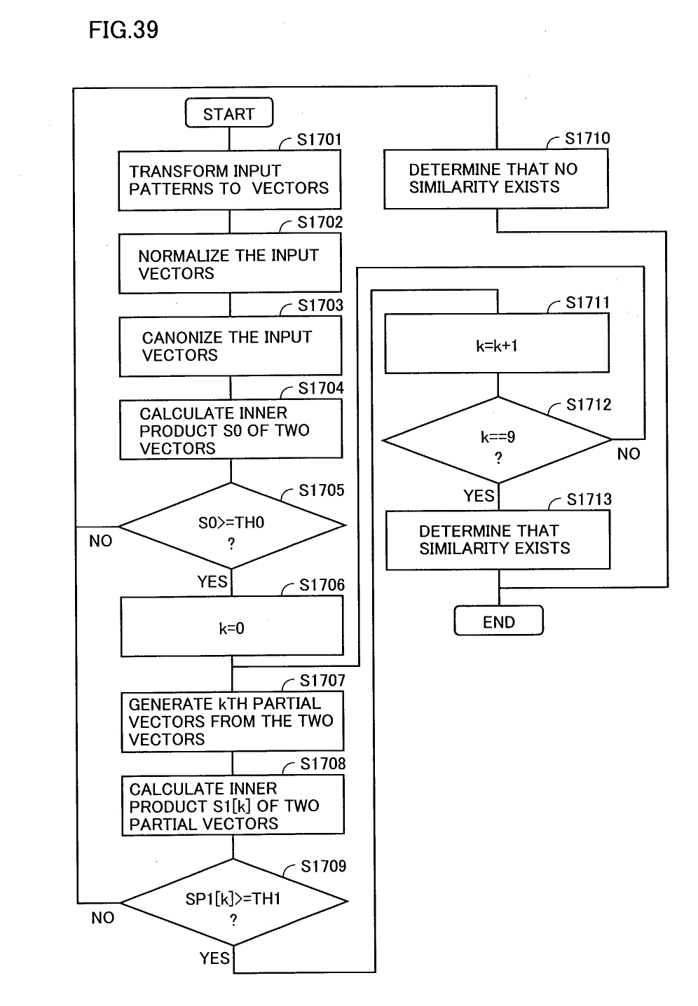

Reference will now be made to FIG. 39 to describe S1107 of FIG. 18.

Vector transformer 1601 extracts features respectively from two input patterns to be compared with each other and generates feature vectors (S1701). The features can be extracted by various techniques, as proposed in the field of character recognition. Herein by way of example the features are extracted, as described hereinafter, and an input pattern is transformed into a feature vector.

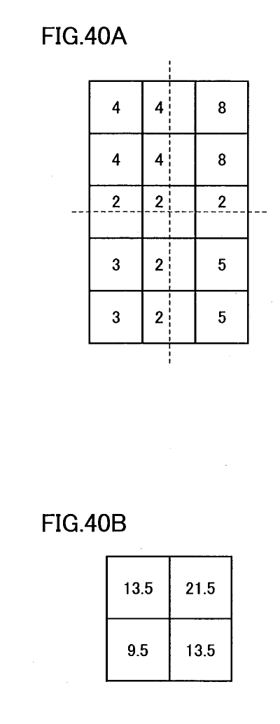

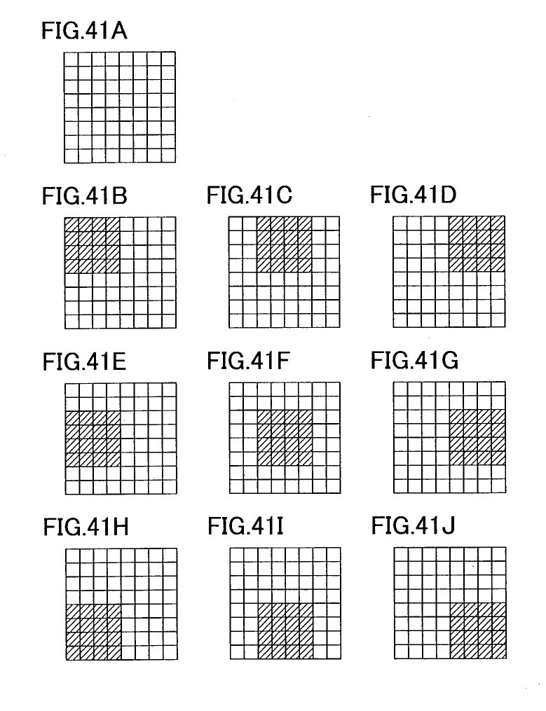

As shown in FIG. 40A, an input pattern formed of 3×5 pixels are equally divided by four. In FIG. 40A a numerical value represents a value of a pixel. The values of the pixels in each block are added together. Note that any pixel divided by two or more blocks has its value assigned to each of the blocks in proportion to the pixel's area contained in the block. Each block has its pixels added together in value, as shown in FIG. 40B, and therefrom is generated a 4-dimensional feature vector. Note that in effect a 64-dimensional (8×8-dimensional) feature vector is calculated, as shown in FIG. 41A.

Vector normalizer 1602 normalizes a feature vector to provide an absolute value of one (S1702). More specifically, vector normalizer 1602 calculates an absolute value of the feature vector and divides each element of the feature vector by the absolute value.

Vector canonizer 1603 canonizes the feature vector (S1703). The “canonization” referred to herein is to calculate a feature vector F′ according to the following equation:

F′=F −(C·F) C (13)

if elements are all identical, C represents feature vector with an absolute value of one and F represents a feature vector of an input pattern generated in S1701, wherein C· F represents an inner product of feature vectors. Feature vector F′ represents an orthogonal vector provided when feature vector F is resolved into two vectors of components parallel and orthogonal to feature vector C of an input pattern with an invariable background. The canonization is provided for the following reason: for a document image or the like a black character is written on white color and a value of a pixel of a background indicates a large value. In particular, for a simple character, a significant portion of an image indicates a large value, and regardless of the type of the input pattern, a feature vector would be similar to that produced from an input pattern which is uniform in density. To prevent this, the canonization is effected.

Inner-product calculator 1604 calculates an inner product S0 of the two feature vectors obtained in S1703 (S1704). The inner product herein is the sum of products of corresponding elements that is divided by the product of the absolute values of two feature vectors, and it assumes a value ranging from zero to one. Inner product S0 having a value approaching one indicates that the two feature vectors are similar and two input patterns are similar.

Controller 1600 determines whether inner product S0 has a value of no less than a predetermined threshold value THO (S1705). If not (NO at S1705) then the controller 1600 determines that they are not similar (S1710) and completes the process.

If inner product S0 has a value of no less than threshold value TH0 (YES at S1705) then controller 1600 initializes counter 1605 to 0 (S1705) to compare portions respectively of the feature vectors (hereinafter referred to as “partial vectors”). Hereinafter counter 1605 will have a value k.

A “partial vector” is a vector produced from a portion extracted from an element of a feature vector. In this scenario, from a 64-dimensional feature vector, such as shown in FIG. 41A, nine, 16-dimensional partial vectors are produced, as shown in FIGS. 41B-41J, respectively, for the sake of illustration. The partial vectors of FIGS. 41B-41J are numbered 0 to 8, respectively.

Partial vector producer 1606 produces kth partial vectors for each of the two feature vectors (S1706). Inner product calculator 1604 calculates an inner product S1[k] of the partial vectors (S1707). Controller 1600 examines whether inner product S1 [k] is no less than a predetermined threshold value TH1 (S1709). If not (NO at S1709) then the controller 1600 determines that they are not similar (S1708) and completes the process.

If inner product S1[k] is no less than threshold value TH1 (YES at S1709) then controller 1600 increments counter 1605 by one (S1709). If counter 1605 does not indicate value k matching the number of the partial vectors (NO at S1712) then the controller 1600 returns to S1707.

If counter 1605 indicates value k matching the number of the partial vectors (YES at S1712) a decision has been made that there is similarity for all partial vectors. A decision is thus made that two input patterns are similar (S1713) and the process ends.

Note that threshold values TH0 and TH1 can be determined independently. Furthermore, different threshold values can also be set for nine partial vectors, respectively. Empirically, threshold value TH0 being larger than threshold value TH1 often results in better results. This is attributed to the fact that partial vectors are compared in accordance with a severe criterion: with feature vectors having their respective, multiple partial vectors compared with each other, a decision that similarity exists is not made if any of the partial vectors fails to have a level of similarity having at least a determined value. By way of example, threshold values TH0 and TH1 are set to be 0.9 and 0.8, respectively.

In this scenario, whether or not two patterns are similar is indicated by an inner product indicating that the two patterns are more similar when it has larger values. Alternatively, an Euclidean distance between partial vectors, a CityBlock distance therebetween or the like, which indicates more similarity when it is small, may be used as a scale. This also applies to comparison of feature vectors in S1705.

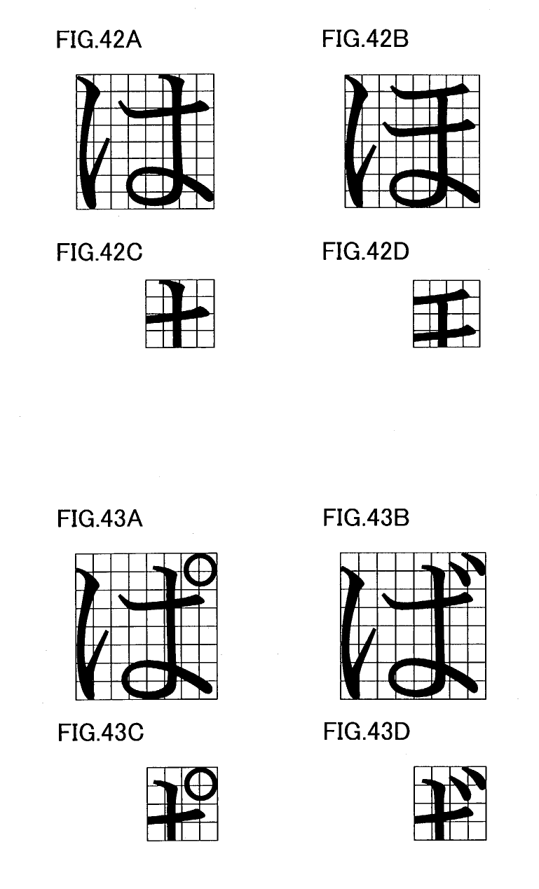

Portions are compared with each other in order to accurately recognize patterns which are similar, as generally observed, but different, as partially observed. FIGS. 42A and 42B show one example of such similar patterns. Such patterns can also be found to be significantly different when their respective, upper right portions alone are extracted, as shown in FIGS. 42C and 42D. By requesting that the two patterns should be similar for all of their partial vectors, accurate recognition can be achieved and patterns representing different characters, such as shown in FIGS. 42A and 42B, can be free from erroneously substitution by a common representative pattern.

Furthermore to extract a representative pattern a loop is detected for the purpose of accurately identifying an input pattern which is difficult to identify if it is partially compared. For example, dissimilar to the examples shown in FIGS. 42A to 42D, those shown in FIGS. 43A and 43B are not only generally similar but also similar at their respective upper right portions considered as having the most significant difference therebetween, as shown in FIGS. 43C and 43D. They, however, have different numbers of loops, and patterns representing different characters, such as shown in FIGS. 43A and 43B, can be free from erroneously substitution by a common representative pattern.

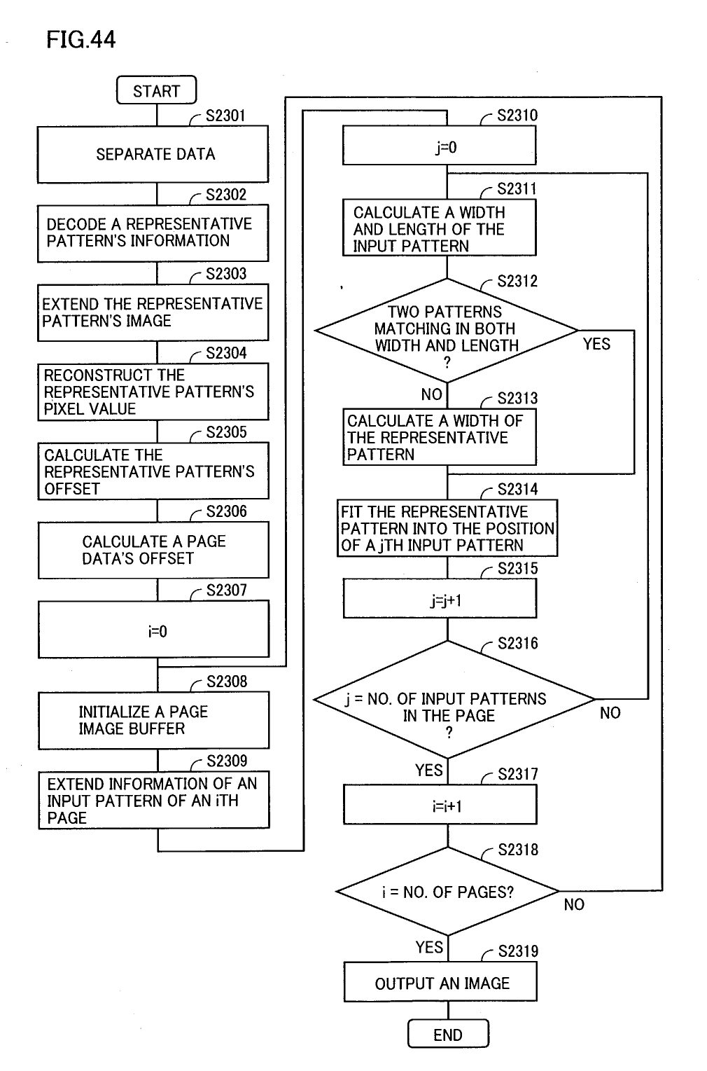

Reference will now be made to FIG. 44 to describe a process for decoding encoded data.

Data separator 2202 separates encoded data in encoded-data buffer 2201 into the FIG. 13 representative pattern information 2101, representative pattern image 2102 an input pattern information 2103. Data separator 2202 transmits representative pattern information 2101 representative pattern image 2102 and input pattern information 2103 to representative pattern information extender 2203, representative pattern image extender 2204 and input pattern compression information buffer 2205, respectively, (S2301).

Representative pattern information extender 2203 extends representative pattern information 2101 and stores it to representative pattern information buffer 2206 (S2302). Representative pattern image extender 2204 extends representative pattern image 2102 and stores it to representative pattern image buffer 2207 (S2303). At that time, representative pattern information buffer 2206 has data stored therein, as shown in FIG. 14, and representative pattern image buffer 2207 has data stored therein, as shown in FIG. 15.

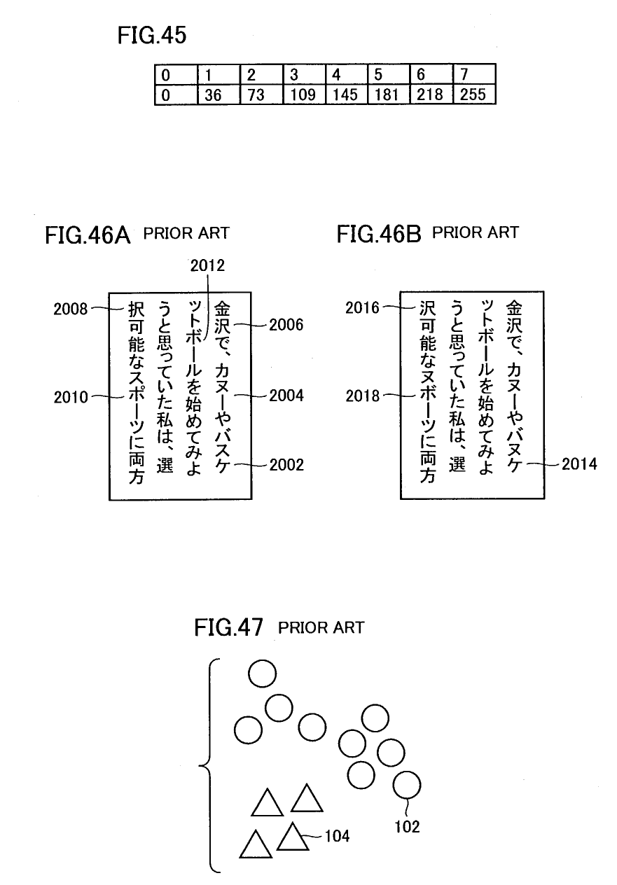

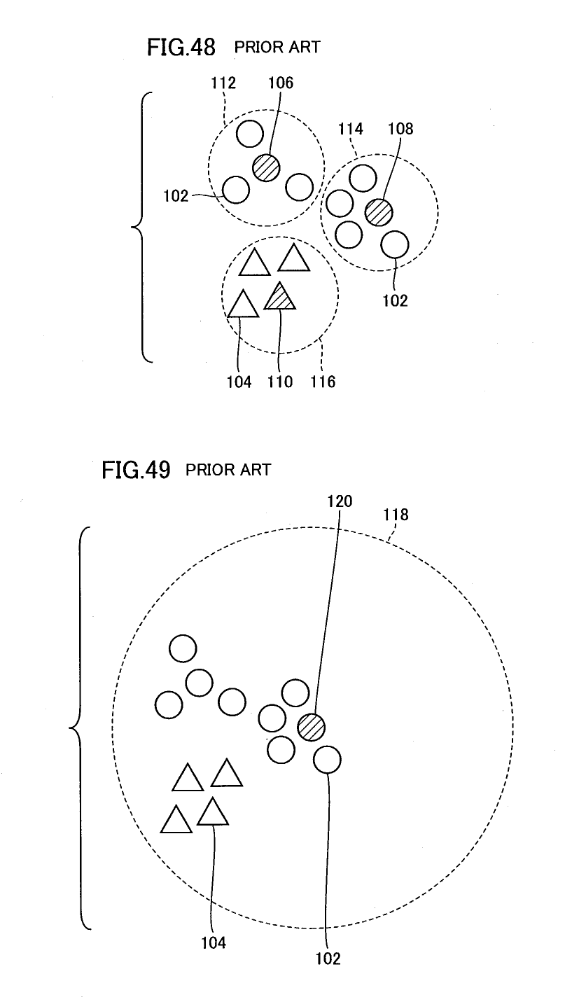

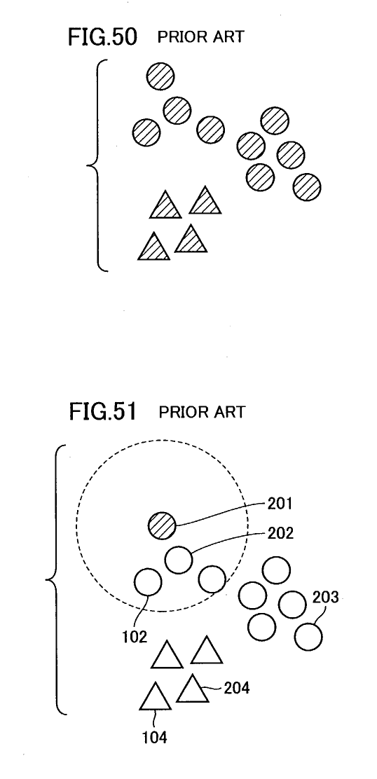

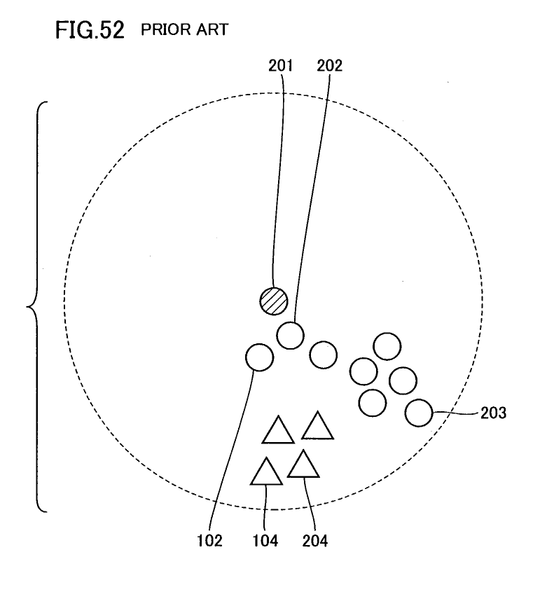

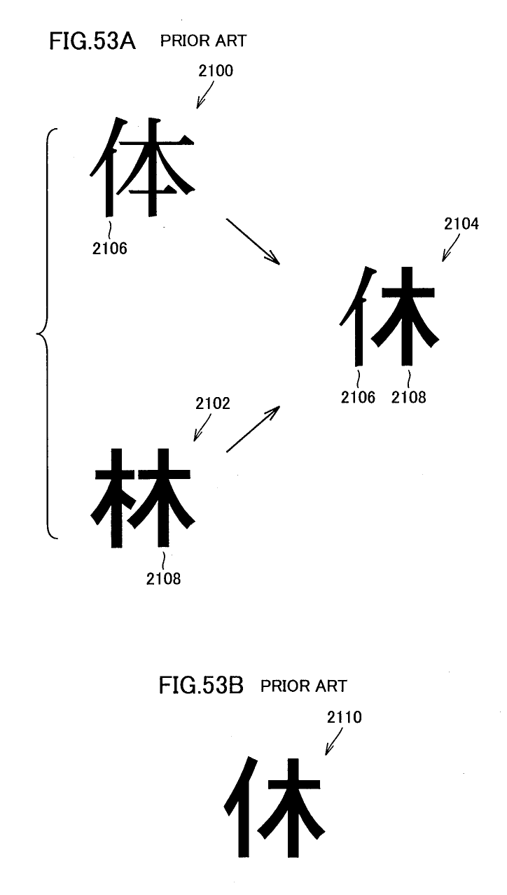

Representative pattern pixel value converter 2208 uses pixel value conversion table 2209 to reconstruct a value of a pixel of a representative pattern stored in representative pattern image buffer 2207 (S2304), so that a value of a pixel reduced in color when it is encoded is reconstructed to have a value that the pixel has in the levels applied before it is encoded. FIG. 45 shows one example of pixel value conversion table 2209, in which the first row indicates an input pixel value and the second row indicates a corresponding output pixel value.

Representative pattern image offset generator 2210 uses data stored in representative pattern information buffer 2206 to calculate the location of each representative pattern in representative pattern image buffer 2207 as an offset from the top of representative pattern image buffer 2207. Representative pattern image offset generator 2210 stores the offset to representative pattern information offset table 2211, which is an array of integers each correlating a representative pattern's number and an offset value one to one (S2305). The product of the width and length of each representative pattern stored in representative pattern information buffer 2206, exactly indicates the quantity of the representative pattern that has been extended. As such, an offset can readily be calculated.

With reference to FIG. 12, input pattern information offset generator 2212 refers to page count 2105 (represented by P), located at the top of input pattern compression information buffer 2205, through quantity 2107 of input pattern data of the (P−1)th page that has been compressed, to calculate the location in input pattern compression information buffer 2205 at which each page data starts. Input pattern information offset generator 2212 writes the result of the calculation to input pattern information offset table 2213 provided in the form of an integer array providing a one to one correspondence between a page number and a location at which page data is stored (S2306). For example, an offset of input pattern data that corresponds to the ith page can be calculated as a sum of quantities of input pattern data of the 0th page through the (i−1)th page that have been compressed.

Page counter 2214 is initialized to 0 (S2307). Hereinafter, page counter 2214 will have a value i. Page image buffer initializer 2216 initializes a value of a pixel of an image in page image buffer 2215 to the same value as a background color (S2308). In this scenario, a background has a color with a value of 225 for the sake of illustration. While in this scenario page image buffer 2215 stores an image with a background having a color of a fixed value, the background may have its color encoded and a pixel having a variable value.

Input pattern information extender 2217 refers to input pattern compression information buffer 2205 and input pattern information offset table 2213 to extend input pattern information contained in the ith page and stores it to input pattern information buffer 2218 (S2309). Input pattern counter 2219 is initialized to 0 (S2310). Hereinafter, input pattern counter 2219 will indicate a value j.

Pixel density converter 2220 uses data in input pattern information buffer 2218 to calculate the width and length of a jth input pattern of the ith page (S2311).

From data stored in input pattern information buffer 2218 and representative pattern information buffer 2206, the width and length of an input pattern and those of a representative pattern representing the input pattern are extracted to compare the input and representative patterns in both width and length. If they do not match in either one or both of width and length (NO at S2312) then pixel density converter 2220 converts any mismatching dimension(s) of the representative pattern to match that (those) of the input pattern (S2313). An image can have its size converted for example by bilinear interpolation, as conventional proposed. These techniques are well known and will not be described repeatedly.

After the representative pattern is matched in width and length to the input pattern (YES at S2313 or S2312) the representative pattern is fit in page image buffer 2215 at a location at which the input pattern exists (S2314).

In this scenario, S2313 is eliminated only when a size completely matches. Alternatively, if a condition is further alleviated or there is not a significant difference in width and length, S2313 may be eliminated to allow a rapid operation without significantly impaired image quality.

Input pattern counter 2219 increments by one (S2114). The control determines whether input pattern counter 2219 indicates value j matching the number of input patterns of the ith page (S2316). If it fails (YES at S2316) then the control returns to S2311 to repeat a similar process for the remaining input pattern(s).

Input pattern counter 2219 indicating value j matching the number of input patterns (YES at S2316) indicates that the ith page has completely been processed and page counter 2214 increments by one (S2319).

The control determines whether page counter 2214 indicates value i matching a page count (S2318) and if not (NO at S2318) then the control returns to S2308 to process the remaining page(s).

Value i matching the page count (YES at S2318) indicates that all pages have completely been processed. An image is output (S2319) and the process ends.

As has been described above in the present embodiment an input pattern is represented as a feature vector and feature vectors have their respective partial vectors compared to partially compare input patterns to distinguish characters which are similar, as generally observed, and dissimilar, as partially observed. An input pattern can less suffer erroneous substitution.

Furthermore, the detection of the number of loops allows different characters also similar, as partially observed, to be distinguished accurately to reduce erroneous substitution of an input pattern.

Furthermore, the extension of a range in similarity of an input pattern in a chain can contribute to a reduced number of patterns representative of input patterns. Data can be encoded with high maintained efficiency.

Furthermore, a representative pattern can be a character cut out of image data. This can eliminate erroneous substitution of an input pattern through character recognition, as introduced when an input pattern undergoes character recognition and a character code is used to represent a representative pattern.

Furthermore, a decoded image can be free of such a discomfort as introduced when a component is used as an input pattern.

For decoding an image, an image can be produced simply by sequentially pasting a representing pattern at a position of a coordinate of an input pattern. The image can thus be reconstructed rapidly.

Furthermore, input patterns can have their coordinates encoded by a unit corresponding to a document page. This can facilitate decoding only an image corresponding to a desired page.

In accordance with the present invention the number of loops in graphics can be calculated more readily by counting the number of loops in a non-background region by noting a background region, detecting therefrom rectangles circumscribing components, and counting the rectangles that are spaced from an edge than by detecting loops and counting the number thereof.

Furthermore, with such a configuration, a condition can readily be imposed on the geometry, size and the like of the opening of a loop to be detected, if it can substitute for a condition related to the geometry, size and the like of a rectangle circumscribing the opening of the loop.

The above-described image encoding and decoding devices can be implemented by a computer and a program operating on the computer. Programs to encode and decode, respectively, an image can be provided in the form of a compact disc-read only memory (CD-ROM) or any other similar computer-readable recording media and the programs may be read and executed by the computer. Alternatively, a program distributed through a network may be received and executed by the computer.

In the present invention input patterns can partially be compared to distinguish characters which are similar, as generally observed, and dissimilar, as partially observed. An input pattern can less suffer erroneous substitution.

Furthermore, the detection of the number of loops allows different characters also similar, as partially observed, to be distinguished accurately to reduce erroneous substitution of an input pattern.

Furthermore, the extension of a range in similarity of an input pattern in a chain can contribute to a reduced number of patterns representative of input patterns. Data can be encoded with high maintained efficiency.

Furthermore, a representative pattern can be a character cut out of image data. This can eliminate erroneous substitution of an input pattern through character recognition, as introduced when an input pattern undergoes character recognition and a character code is used to represent a representative pattern.

For decoding an image, an image can be produced simply by sequentially pasting a representing pattern at a position of a coordinate of an input pattern. The image can thus be reconstructed rapidly.

Furthermore, in order to extend a range in similarity of an input pattern, in inspecting each pair of input patterns in similarity a data structure is assumed to store information in similarity of all pairs of input patterns having so far been compared. This allows a final result to be obtained simply by inspecting each pair of input patterns in similarity only once.

Furthermore, by assuming such a data structure and by determining a registration pattern corresponding to an input pattern by comparing exact input patterns, rather than using a pattern composited from an input pattern varying during a process, an identical, a single final result can be obtained in whatever sequence each input pattern may be compared.

Industrial Applicability

As described above, in the present invention, characters which are similar, as generally observed, and dissimilar, as partially observed, can be distinguished to reduce erroneous substitution of an input pattern. The present invention is thus applicable to high-performance image encoding and decoding devices.

1. An image encoding device comprising:
an input pattern extractor extracting an input pattern from image data;
a representative pattern extractor connected to said input pattern extractor to compare extracted input patterns with each other for each constituent portion of the input patterns to extract a single representative pattern from similar input patterns; and
an encoding portion encoding an image of said representative pattern and a position of a coordinate of said input pattern.

2. The image encoding device of claim 1, wherein said representative pattern extractor includes:
a portion matching portion connected to said input pattern extractor to compare extracted input patterns for each constituent portion of the input patterns;
a loop detection portion connected to said input pattern extractor to detect a number of annular portions in said input pattern; and
a circuit connected to said portion matching portion and said loop detection portion and using outputs from said portion matching portion and said loop detection portion, respectively, to examine similarity between input patterns to be compared with each other, to extract a single representative pattern from similar input patterns.

3. An image encoding device comprising:
an input pattern extractor extracting an input pattern from image data;
a similarity enlarging portion connected to said input pattern extractor to set as an input pattern similar to an each extracted input pattern an input pattern dissimilar to the extracted input pattern and similar to an input pattern similar to the extracted input pattern;
a representative pattern extractor connected to said similarity enlarging portion to compare extracted input patterns to extract a single representative pattern from input patterns determined as being similar to each other; and
an encoding portion encoding an image of said representative pattern and a position of a coordinate of said input pattern.

4. An image encoding device comprising:
an input pattern extractor extracting an input pattern from image data;
a loop detection portion connected to said input pattern extractor to detect a number of annular portions in an extracted input pattern;
a representative pattern extractor connected to said loop detection portion to receive an output from said loop detection portion for use in examining similarity between input patterns to be compared with each other, to extract a single representative pattern from similar input patterns; and
an encoding portion encoding an image of said representative pattern and a position of a coordinate of said input pattern.

5. The image encoding device of claim 1, wherein said representative pattern is a character cut out of said image data.

6. An image decoding device decoding an image from data encoded by the image encoding device as recited in claim 1, comprising:
an image generation data extraction portion extending encoded data and extracting an image of a representative pattern and a position of a coordinate of an input pattern; and
a representative pattern pasting portion connected to said image generation data extraction portion to paste at the position of the coordinate of the input pattern a representative pattern representing the input pattern.

7. A method of encoding an image, comprising the steps of:
extracting an input pattern from image data;
comparing extracted input patterns for each constituent portion of the input patterns to extract a single representative pattern from similar input patterns; and
encoding an image of said representative pattern and a position of a coordinate of said input pattern.

8. A method of decoding an image from data encoded by the method as recited in claim 7, comprising the steps of:
extending encoded data and extracting an image of a representative pattern and a position of a coordinate of an input pattern; and
pasting at the position of the coordinate of the input pattern a representative pattern representing the input pattern.

9. A computer-readable recording medium having recorded therein a computer-executable program of a method of encoding an image, said method comprising the steps of:
extracting an input pattern from image data;
comparing extracted input patterns for each constituent portion of the input patterns to extract a single representative pattern from similar input patterns; and
encoding an image of said representative pattern and a position of a coordinate of said input pattern.

10. A computer-readable recording medium having recorded therein a computer-executable program of a method of decoding an image, said method comprising the steps of:
decoding an image from data encoded by the method as recited in claim 9;
extending encoded data and extracting an image of a representative pattern and a position of a coordinate of an input pattern; and
pasting at the position of the coordinate of the input pattern a representative pattern representing the input pattern of interest.
